(19) United States
(12) Patent Application Publication
(10) Pub. No.: US 2022/0044277 A1
(43) Pub. Date: Feb. 10, 2022

(54) COMPUTERIZED HUB FOR INTERACTION OF SERVICE PURCHASERS AND SERVICE PROVIDERS FOR REAL-TIME GENERATION AND ADJUSTMENT OF SERVICES

(71) Applicant: Business Powered.com, LLC, Collegeville, PA (US)

(72) Inventor: Timothy Geiger, Collegeville, PA (US)

(21) Appl. No.: 17/327,638

(22) Filed: May 21, 2021

Related U.S. Application Data
(60) Provisional application No. 63/029,353, filed on May 22, 2020.

(51) Int. Cl. G06Q 30/02; G06Q 10/10; G06Q 10/06

(52) U.S. Cl. CPC G06Q 30/0246; G06Q 30/0249; G06Q 30/0264; G06Q 10/1097; G06Q 10/06393; G06F 3/0482; G06Q 30/0201; G06Q 30/0214; G06Q 10/105; G06Q 30/0273; G06Q 10/103

(57) ABSTRACT

A computerized hub connects companies seeking marketing services and marketing companies that provide marketing services. The systems and methods first provide hub-based tools to allow the company to develop a high-level marketing plan in accordance with the company's type of business, industry, geographic location, and marketing budget. Tool are also provided to facilitate budgeting, selecting, planning, launching, and reporting. In embodiments, the hub will have APIs to allow customers to provide a link to the customer's scheduling and accounting software to help develop the marketing plan and to monitor the effectiveness of the plan. The hub provides also provides interfaces for receiving performance data from marketing companies so their services may be offered to marketing service purchasers. Once a marketing company is selected, it is provided with additional interfaces which specify the campaigns and tasks for which the marketing company is responsible to implement. The computerized also provides real-time marketing results based upon real-time sales and marketing data, and generates updated marketing campaigns based upon triggers applied to the real-time sales and marketing data.

### CROSS-REFERENCE TO RELATED APPLICATIONS

This application claims the benefit of U.S. Provisional Application 63/029,353 filed on May 22, 2020, the entire contents of which are herein incorporated by reference for all purposes.

### FIELD OF THE INVENTION

In general, the invention relates to computerized hub that facilitates interaction between service purchasers and service providers. More specifically, the invention provides a marketplace for purchase and provision of marketing services that facilitates real time budgeting, planning, implementation, results monitoring.

### BACKGROUND OF THE INVENTION

The Internet has made information readily available to purchasers of services, such as purchasers of HVAC services or purchasers of plumbing services. Web sites such as Google™, AngiesList™, and Yelp™ provide numerous reviews of service providers, and purchasers often rely on these reviews to select a service provider.

In addition, the ubiquity of the Internet and social media web sites has made it very easy for service providers to advertise. Internet-savvy companies have learned to leverage advertising in social media, and often times it is the internet-savvy companies, rather than established companies providing the best services, that are becoming known to consumers through the advertising.

For many companies, especially established companies that, pre-Internet, built their reputation through word-of-mouth and repeat business that comes with good service, the Internet has disrupted the normal marketing of services. Marketing is the process of persuading potential consumers to buy the organization's product or service. Marketing services are the methods used in the overall marketing plan of production, pricing, promotion and distribution. While these companies are familiar with traditional marketing such as on radio, in magazines, and on saver flyers, many of these companies simply are unaware of how to go about marketing their services on the Internet, and unaware of how to distribute their marketing dollars among many different channels. Yet, these companies understand how powerful Internet advertising and Internet reviews are in driving business in today's marketplace. Therefore, while doing nothing is not an option to these businesses, many of these businesses do not have the time or resources to implement effective marketing in the Internet age.

In addition to lacking time and resources, most companies, particularly smaller companies, lack the knowledge to develop a marketing plan, and lack knowledge on how to determine whether or not (and to what degree) their marketing plans are effective.

In addition, companies lack organized referral systems, even though, even in the Internet marketing environment, word-of-mouth and referrals are still the most effect manner of marketing business. Even when a company may have referral system, that system may not be tied into its marketing efforts.

Still further, companies lack knowledge of all of the different marketing avenues available for advertising. For example, many companies are not aware that outlets such as Instagram, Twitter®, and YouTube® may be used for marketing. Autoselection of outlets and tracking of performance provides a solution to this lack of knowledge.

Companies may also lack knowledge of how competitors may use negative advertising to gain an advantage. For example, negative Search Engine Optimization (SEO) attacks are very easy for competitors to implement, and can greatly drop a business's web site rankings.

While a company can engage a marketing company for advertising services, for many smaller and medium sized companies this is seen as a significant undertaking in which “big” companies engage. It is an intimidating prospect, and seen as a very expensive undertaking. Because there is no centralized marketplace for marketing companies and freelancers, the companies will typically be required to consult with different marketing services companies and freelancers individually as shown in FIG. 1, adding to the complexity of the undertaking. As shown in FIG. 1, in the prior art 100, a purchasing company 110 (a company seeking to purchase marketing services) seeking marketing services may have to directly contact numerous marketing service providers (150, 160, 170) and freelance providers (120, 130, 140) to find a marketing company and freelancers that understand their business and which are able to develop an appropriate marketing plan to market the business. Typically, the contacts between the purchasing company, the marketing companies, and freelancers are manual contacts that are not computerized. For example, a purchasing company will typically require in-person meetings with different marketing companies to develop possible marketing plans. These manual contacts add to the time, expense, and complexity for companies seeking marketing services.

Alternative systems and methods are desired.

### SUMMARY OF THE INVENTION

Prior technological systems that perform computerized functions in an ordered combination of operations deter users from accessing and/or operating such computerized systems by virtue of their particular processing operations, and diminish the numbers of those partaking in online or electronic marketplaces, which in turn, diminishes the effectivity, efficiency, and viability of prior art technological solutions to address real-world problems in real-time fashion. In contrast, the ordered combination of computer performed functions, computer components, and user interactions with those ordered combinations as recited in the present disclosure, transform the technological system and technical process steps implemented herein into one that technologically facilitates user interaction via an iterative, software hub, with multiple different ranging operations dependent on user input, as well as ordered combinations of operations and temporal interactive feedback processing from external sources for adjustment of forecasts and temporal adjustment of actions to be taken in accordance with forecasts and predictive processing, none of which are conventional in connection with e-commerce and marketplace platforms of the prior art. The present disclosure thus provides for a technological system and implementation of ordered combinations of elements and process steps that result in a more robust, efficient, real-time system, that not only aggregates separate providers and functionalities, but synthesizes multiple independent connections within the technological platform to enable development, tracking, monitoring, projection, and adjustment of integrated actions and responses within the computerized system.

Embodiments of the disclosed system and method provide a solution for marketing problems for each supply chain position. What local businesses are looking for in their marketing is:
1. A system that will help the business know who to hire
2. A system that will help business know what channels to market
3. A system that will help business with strategy
4. A system that will help business with implementing and planning
5. Marketing that can be turned on or off, increase area, or adjust as needed
6. Marketing that does not take a lot of my time
7. Marketing that will support business financial goals
8. Marketing that will bring in the right customers
9. Marketing that will lower cost per customer acquisition in each department
10. Marketing that will create top of mind awareness for the brand
11. Marketing that will keep customers
12. Marketing that will leverage existing customers for new customers
13. Marketing that can be managed by labor primarily if weather-driven or seasonal
14. Marketing that provides a good ROI
15. Marketing that is easy to use.

Accordingly, systems and methods are disclosed herein for implementing a computerized hub (hub computer platform) to connect companies seeking marketing services and marketing companies that provide marketing services. The systems and methods first provide hub-based tools to allow the company to develop a high-level marketing plan in accordance with the company's type of business, industry, geographic location, and marketing budget. Tool are also provided to facilitate budgeting, selecting, planning, launching, and reporting. In embodiments, the hub will have APIs to allow customers to provide a link to the customer's scheduling and accounting software to help develop the marketing plan and to monitor the effectiveness of the plan.

In addition, hub-based tools are provided to marketing companies to allow them to provide services through the hub. Once a company has developed a high-level marketing plan or campaign through the hub, it may hire a marketing company to implement the tasks required for the campaign. In embodiments, the hub includes background, rating, and pricing information for each of the marketing companies, to allow companies seeking marketing services to compare the marketing companies. In embodiments, the hub also includes tools to allow individual free-lancers to provide services through the hub. The hub may include background, rating, and pricing information for each of the freelancers, to allow marketing companies to assign individual tasks to freelancers to launch the marketing campaign.

The hub computer platform may be configured to facilitate interaction between any number of entities, including companies seeking marketing services, marketing companies providing marketing services, freelancers and advertising agencies working for the marketing companies, DIY companies hiring freelancers and advertising agencies. In another embodiment, the hub computer platform may be configured to also, or alternatively, facilitate interaction between including companies seeking business services, companies providing business services, freelancers and business consultant agencies working for companies providing business services, DIY companies hiring freelancers and business consultants. The hub computer platform may be configured to facilitate interactions between companies seeking business services and companies providing business services in a similar fashion in which it facilitates interaction between companies seeking marketing services and companies providing marketing services.

Embodiments of the present disclosure provide a technical solution including automated detection, notification, alarms and processing that track back links, business listings, duplicated content and negative intent in reviews. Embodiments of the present disclosure provide for detection of events which may be classified as suspicious activity and provides alerts/alarms to notify a credentialed manager or user.

An embodiment of the disclosure includes a software hub that allows companies to use for all their marketing in real time to budget, plan, implement, monitor results and a marketplace to purchase their marketing services. The software includes API's to the customers scheduling and accounting software to make sure goals are always met to the best of their ability.

Marketing companies' performance is always tracked with Key Performance financial numbers. This allows companies to select marketers with less risk and greater results.

Real time API connections allow companies a daily weekly and monthly view of marketing and sales goals and automates starting and stopping additional marketing spends or different campaigns as needed.

Combining all marketing companies in one hub simplifies trying to find the right marketing Firm or individual suitable to your needs before you need them and embodiments of the present computer system implements the marketing process.

### BRIEF DESCRIPTION OF THE DRAWINGS

FIG. 1 is a block diagram of prior art interactions between a company seeking marketing services and marketing companies and freelancers.

FIG. 2 is a block diagram of a system including the computerized hub, purchaser computer systems, marketing company computer systems, and freelance computer systems.

FIG. 3 is block diagram of an embodiment of the hub computer system.

FIG. 4 is a block diagram of a process implemented by the hub computer system.

FIGS. 4A-4Y are exemplary user interfaces generated by the hub computer system.

FIGS. 5A-5C are block diagrams of a process implemented by the hub computer system.

FIGS. 5D-5M are exemplary user interfaces generated by the hub computer system.

FIG. 6 is a depiction of a referral program.

FIGS. 7A-7E are block diagrams of a process that may be implemented by the hub computer system.

FIG. 8 is a depiction of a heat map that may be generated by the hub computer system.

FIG. 9 is a depiction of an industry list that may be generated by the hub computer system.

FIG. 10 is a depiction of a Marketing Results spreadsheet.

FIGS. 11A-11D depict a Performance Summary Spreadsheet which is generated by the hub computer system.

FIG. 12 depicts an exemplary HVAC inspection checklist with status colors corresponding to the status of individual systems or functions which have been inspected.

FIG. 13 depicts a Maps SEO Checklist that may be applied by the Inspection Station.

FIG. 14 depicts an Entity SEO Checklist that may be applied by the Inspection Station.

FIG. 15 depicts an Output Table that may be generated by the Inspection station based upon application of checklists to individual tasks or marketing channels.

FIG. 16 depicts an Off-Page Activities Checklist of marketing tasks.

FIG. 17 depicts Online Reputation Management marketing tasks.

FIG. 18 depicts On-Page Optimization marketing tasks.

FIG. 19 depicts social media channels on which marketing may be targeted and on which the inspection station checklists may be applied.

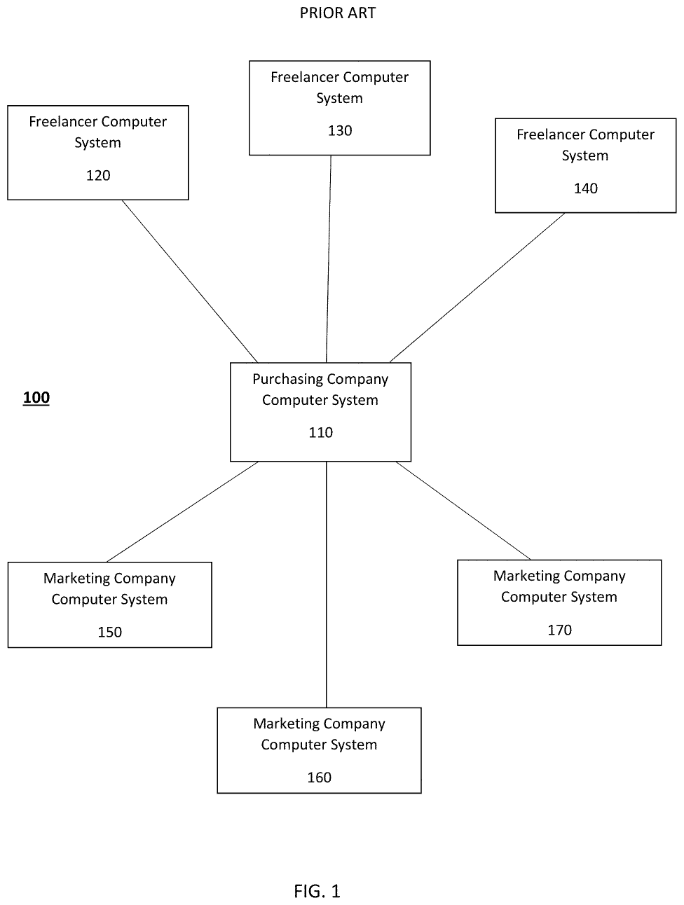

### DETAILED DESCRIPTION

To provide an overall understanding of the invention, certain illustrative embodiments will now be described, including systems and methods for implementing a centralized hub computer platform. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

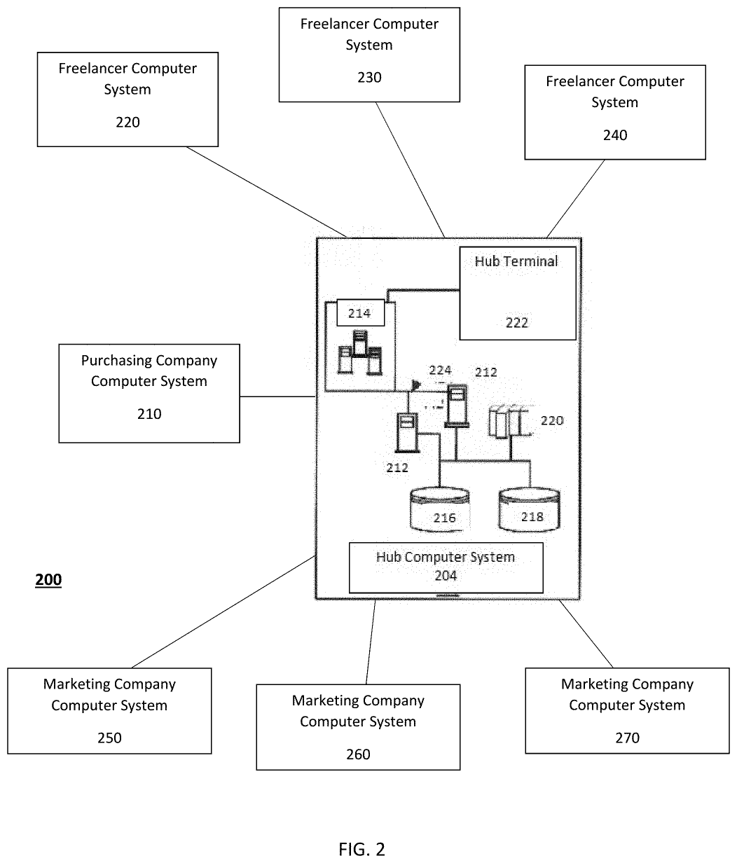

In the embodiment illustrated in FIG. 2, the hub computer system 204 includes application servers 212, a purchaser database 216, a provider database 218, a processing unit 220, and hub terminal 222. These computing devices may be connected by a local area network 224.

The application servers 212 are responsible for interacting with the Purchasing Company Computer System 210, and Provider Company Computer Systems such as Marketing Company Computer Systems 250, 260, and 270 and Freelancer Computer Systems 220, 230, and 240. For example, the application servers 212 store and execute software for generating web pages for communication to the Purchasing Company Computer System 210, Marketing Company Computer Systems 250, 260, and 270, and Freelancer Computer Systems 220, 230, and 240. These web pages serve as user interfaces for the Purchasing Company Computer System 230, Marketing Company Computer Systems 250, 260, and 270, and Freelancer Computer Systems 220, 230, and 240 to interact with the hub computer system 204. In embodiments, alternatively, or in addition, one or more of the application servers 212 may be configured to communicate with thin or thick clients operating on the Purchasing Company Computer System 210, Marketing Company Computer Systems 250, 260, and 270, and Freelancer Computer Systems 220. Load balancing proxy servers 214 may operate to distribute the load among application servers 212. Although not shown, the system may further include freelancer and advertising agency computer systems for freelancers and advertising agencies working for marketing companies or DIY companies (and associated marketing company computer systems and DIY computer systems) which have hired freelancers and advertising agencies, and business entities and consultants providing business services to companies seeking business services, and the business entity systems (and associated business consultant computer systems). While FIG. 2 only depicts a single Purchasing Company Computer System, it is understood that the hub computer system 204 is designed to facilitate a plurality of Purchasing Company Computer Systems to interact with a plurality of Marketing Company Computer Systems and Freelancer Computer Systems. In addition, hub computer system 204 may also facilitate interaction between Purchasing Company Computer Systems and the computer systems of business entities involved with marketing, including, but not limited to, an advertising agency computer system or the computer system of any other type of business entity involved with marketing.

The Purchasing Company database 216 stores information about marketing campaigns and tasks developed on the hub computer system 204. For each purchasing company, the database 216 includes for example and without limitation, the following data: industry data, geographical data, budgeting data, responsibility and contact data, marketing requirements data, historical marketing performance data, marketing campaign data, ad schedule data, performance trigger data, and performance summary data. Additionally, a Provider Company database 218 includes information related to providers of marketing services such as marketing companies and freelance marketing service providers, and may include for each provider company, for example and without limitation, the following data: company or freelance provider name, company or freelance provider rating, company or freelance provider reviews, company or freelance provider skills, company or freelance provider cost per lead, company or freelance provider cost per sale, company or freelance provider performance percentage on spend, company or freelance provider flat rate marketing management, and whether the company or freelance provider is accepting customers. In embodiments, a single database may be used for storing data from both the Purchaser Company database 216 and the Provider Company database 218. A logical database may be stored in one or more physical data storage devices which may be co-located or located at different facilities.

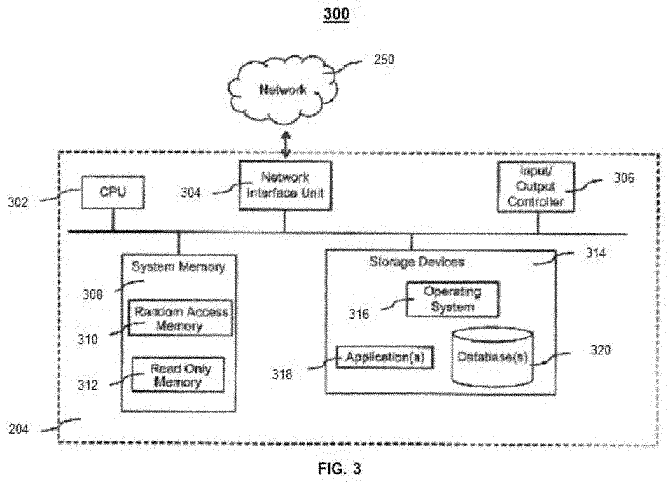

The processing unit 220 is configured for generating a marketing campaign for a Purchaser Company that is to be carried out by a Provider Company. The processing unit 220 may comprise multiple separate processors, such as a content processor, which retrieves content from client sources such as client budgeting and marketing databases, over the communications network (depicted as the lines connecting the different computer systems in FIG. 2) which connects the hub computer system 204 to the Purchasing Company Computer System 210, and Provider Company Computer Systems such as Marketing Company Computer Systems 250, 260, and 270 and Freelancer Computer Systems 220, 230, and 240. The processing unit 220 may also comprise a user interface processor, which generates user interfaces for presenting information to, and obtaining information from, either the Purchaser Company or one or more Provider Companies. The processing unit 220 also includes a computer processor, which, among other things, is configured to generate Marketing Plans and Performance Summaries for a Purchaser company. An exemplary implementation of a computing device for use in the processing system 220 is discussed in greater detail in relation to FIG. 3.

The hub terminal 222 may provide various user interfaces to hub company employees to interact with the processing system 220. The interfaces include, without limitation, interfaces to communicate with a Purchaser Company to guide the company in the development of a Marketing Campaign. For example, hub employees may be able to retrieve interfaces with information on budgeting and marketing entities when assisting purchaser companies with developing marketing campaigns. The hub terminals 222 can be any computing devices suitable for carrying out the processes described above, including personal computers, laptop computers, personal digital computers, smart phones, servers, and other computing devices.

The Purchasing Company Computer System 210, and Provider Company Computer Systems such as Marketing Company Computer Systems 250, 260, and 270 and Freelancer Computer Systems 220, 230, and 240 can be any computing devices suitable for carrying out the processes described above, including personal computers, laptop computers, personal digital computers, smart phones, servers, and other computing devices. In an embodiment, the Purchasing Company Computer System 210 and the Marketing Company Computer Systems 250, 260, and 270 may comprise enterprise computer systems that include accounting and/or marketing subsystems. The Purchasing Company Computer Systems 210 and the Marketing Company Computer Systems 250, 260, and 270 may have application programming interfaces (APIs) that are configured to permit the Hub Computer System to access financial and sales data, and scheduling data, relevant to the generation, monitoring, and updating of Marketing Campaigns developed using the Hub Computer System.

FIG. 3 is a block diagram of an exemplary hub computer system 204 of FIG. 2, according to an illustrative embodiment of the invention. The hub computer system 204 may include at least one network interface unit 304, an input/output controller 306, system memory 308, and one or more data storage devices 314. The system memory 308 includes at least one random access memory (RAM) 310 and at least one read-only memory (ROM) 312. All of these elements are in communication with a central processing unit (CPU) 302 to facilitate the operation of the external computing device 300. The hub computer system 204 may be configured in many different ways. For example, the hub computer system 204 may be a standalone computer or alternatively, the functions of hub computer system 204 may be distributed across multiple computer systems and architectures. In the embodiment shown in FIG. 2, the hub computer system 204 is linked to other systems via network 250.

The hub computer system 204 may be configured in a distributed architecture, wherein databases and processors are housed in separate units or locations. The hub computer system 204 may also be implemented as a server located either on site. Some such units perform primary processing functions and contain at a minimum a general controller or a processor 302 and a system memory 308. In such an embodiment, each of these units is attached via the network interface unit 304 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 302 comprises a processor, such as one or more microprocessors and one or more supplementary co-processors such as math co-processors for offloading workload from the CPU 302. The CPU 302 is in communication with the network interface unit 304 and the input/output controller 306, through which the CPU 302 communicates with other devices such as other servers, user terminals, or devices. The network interface unit 304 and/or the input/output controller 206 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 302 is also in communication with the data storage device 314. The data storage device 314 may comprise an appropriate combination of magnetic, optical and/or semiconductor memory, and may include, for example, RAM, ROM, flash drive, an optical disc such as a compact disc and/or a hard disk or drive. The CPU 302 and the data storage device 314 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 302 may be connected to the data storage device 314 via the network interface unit 304.

The CPU 302 may be configured to perform one or more particular processing functions. For example, the hub computer system 304 may be configured as a user interface processor. The user interface processor may be configured to generate a series of user interfaces for obtaining marketing-related data from entities seeking to purchase marketing services. The user interface processor may generate interfaces using text, images, or other formats delivered through HTML, SVG, Java applets, Adobe FLASH, Adobe SHOCKWAVE, Microsoft SILVERLIGHT, or other web formats or applications. In embodiments, the hub computer system 304 or another similar computing device may be configured as a predictive model processor.

The data storage device 314 may store, for example, (i) an operating system 316 for the hub computer system 204; (ii) one or more applications 318 (e.g., computer program code and/or a computer program product) adapted to direct the CPU 302 in accordance with the present invention, and particularly in accordance with the processes described in detail with regard to the CPU 302; and/or (iii) database(s) 320 adapted to store information that may be utilized to store information required by the program.

The operating system 316 and/or applications 318 may be stored, for example, in a compressed, uncompiled and/or an encrypted format, and may include computer program code. The instructions of the program may be read into a main memory of the processor from a computer-readable medium other than the data storage device 314, such as from the ROM 312 or from the RAM 310. While execution of sequences of instructions in the program causes the CPU 302 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for generating the interfaces required by the hub computer system to interface the functionality required by the purchasing companies, the marketing companies, and the freelancers. The program also may include program elements such as an operating system, a database management system and “device drivers” that allow the processor to interface with computer peripheral devices (e.g., a video display, a keyboard, a computer mouse, etc.) via the input/output controller 306.

The term “computer-readable medium” as used herein refers to any non-transitory medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 302 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

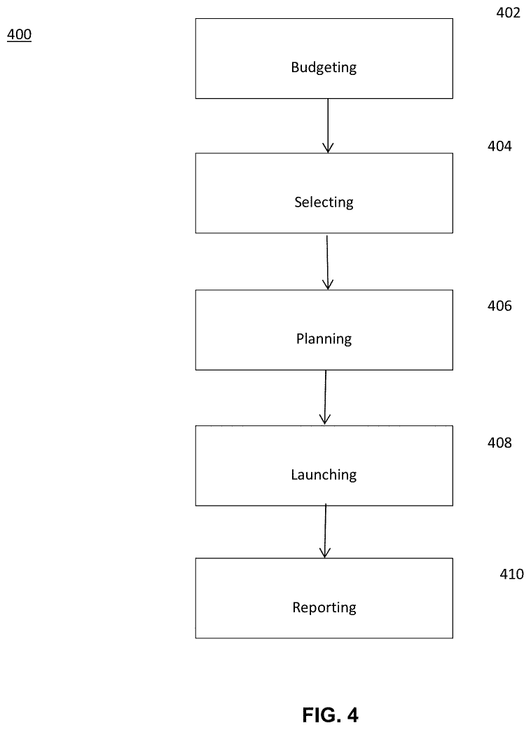

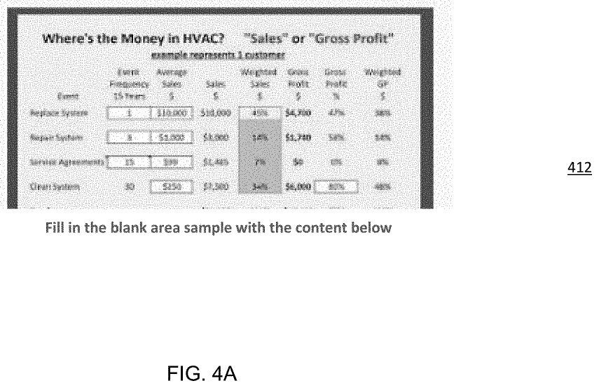

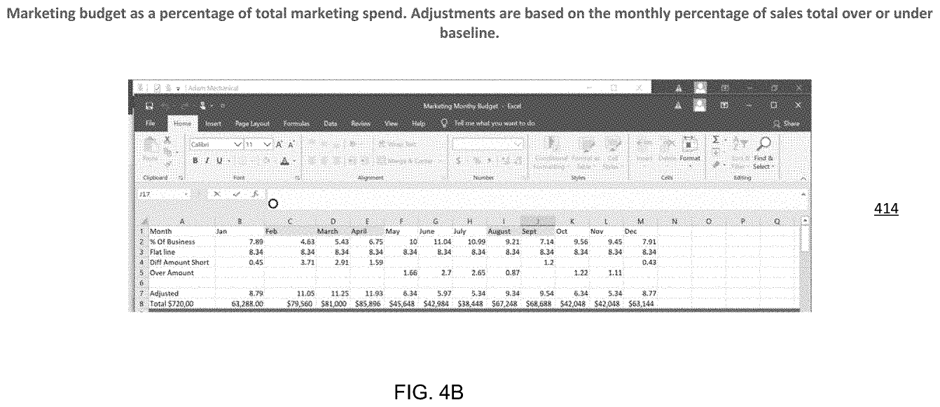

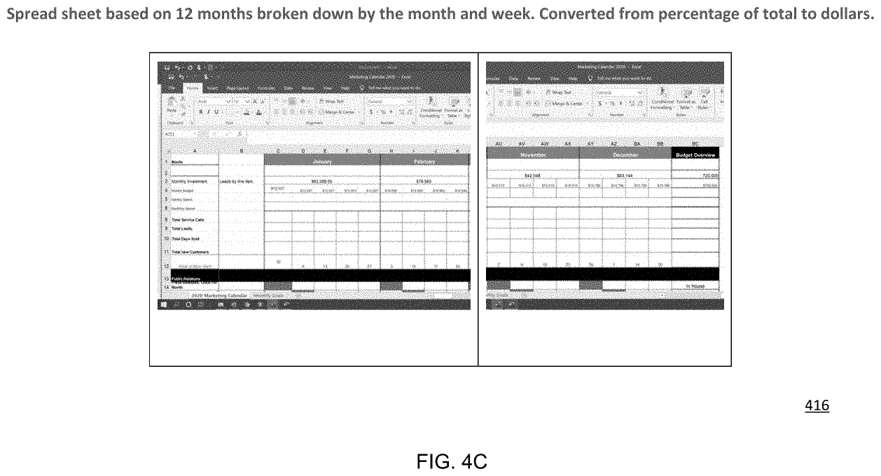

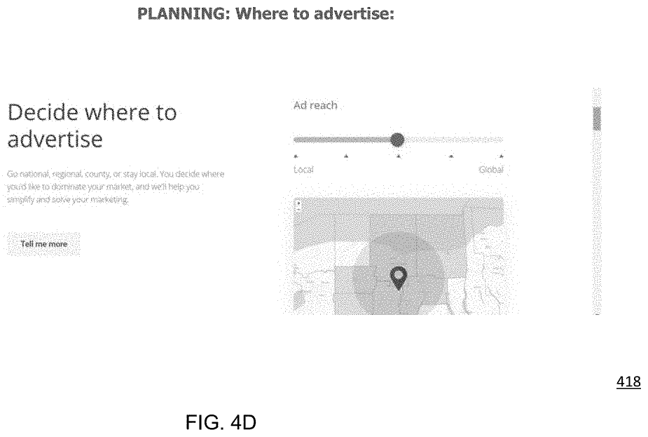

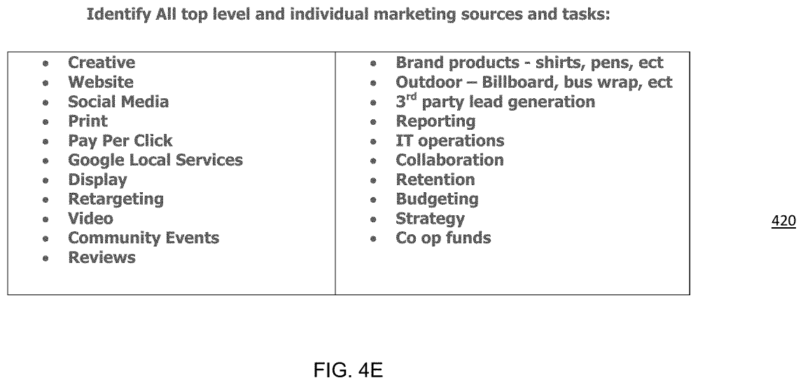

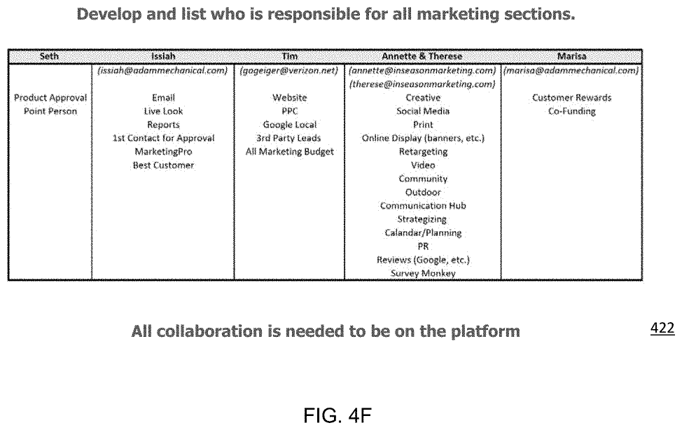

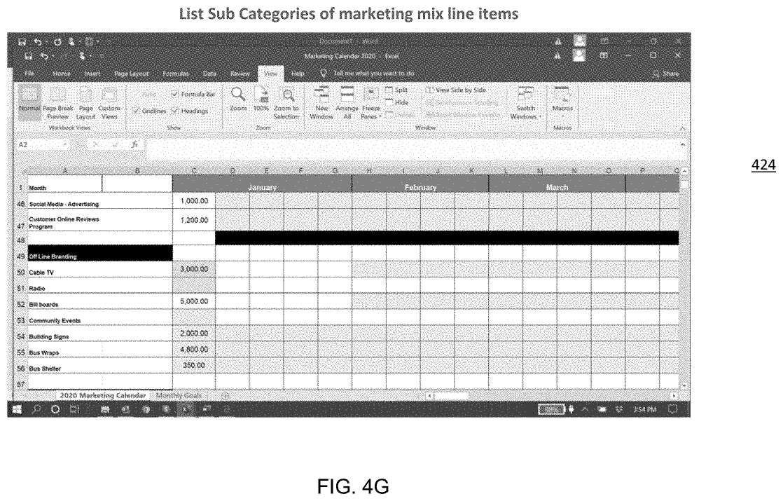

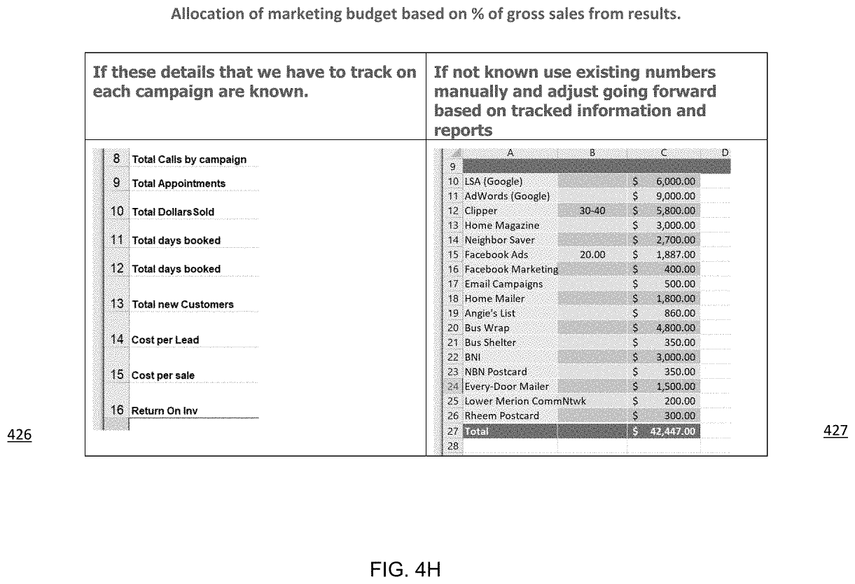

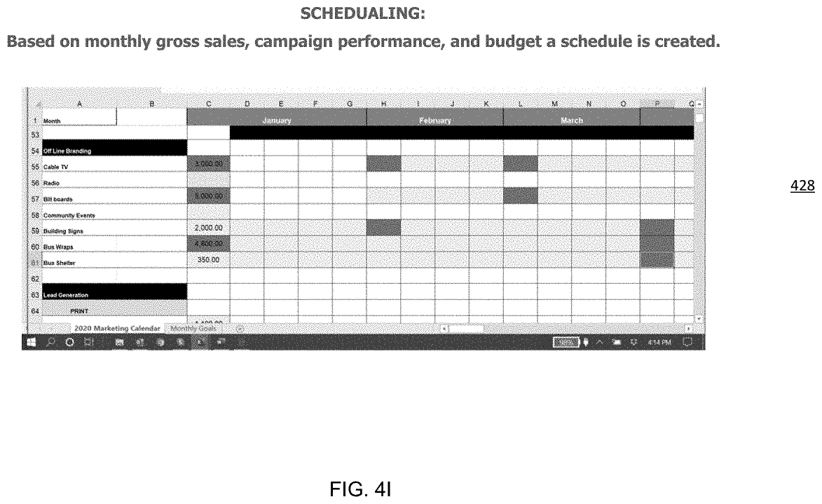

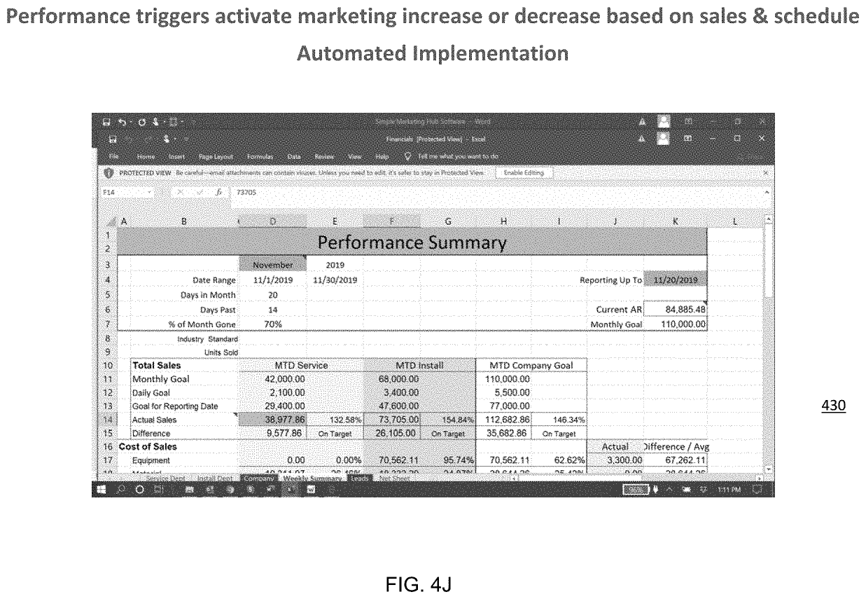

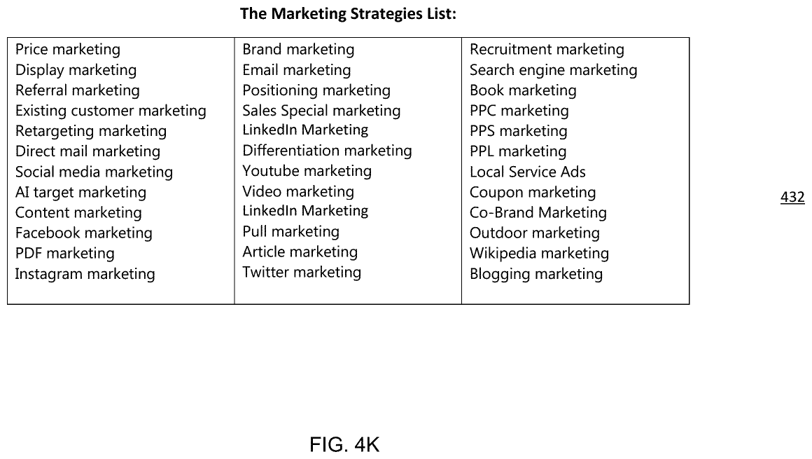

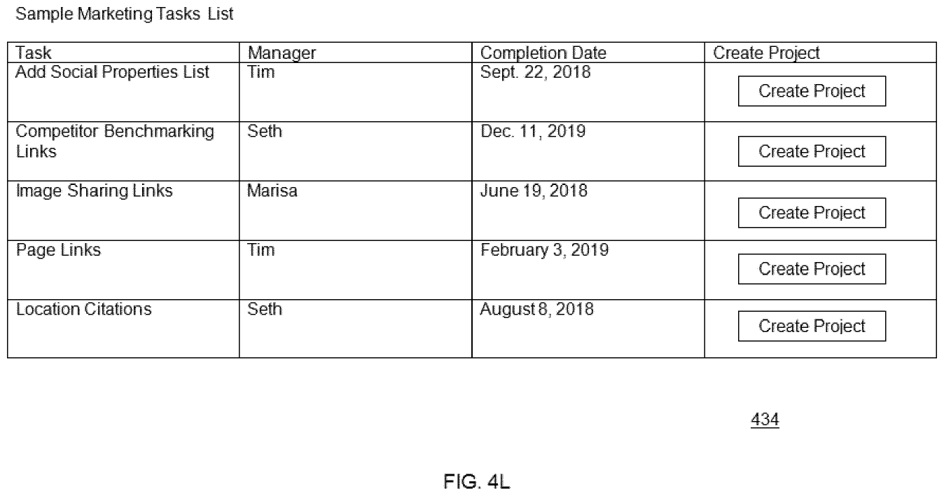

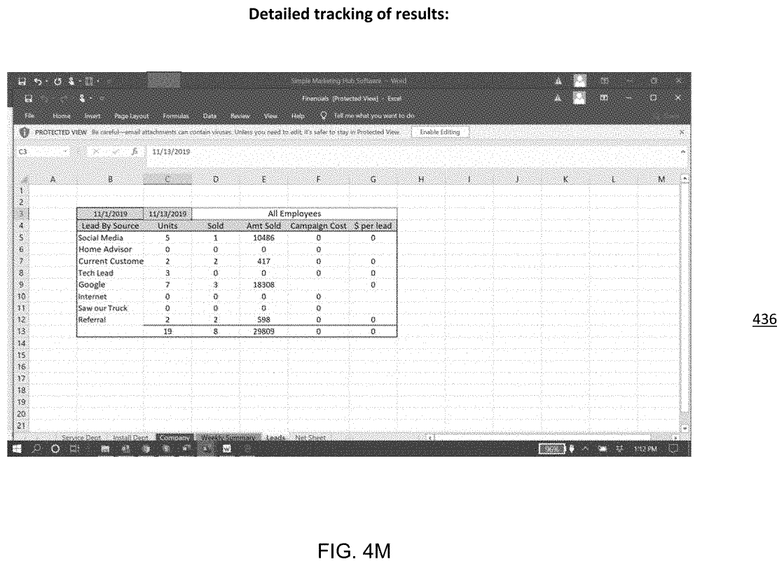

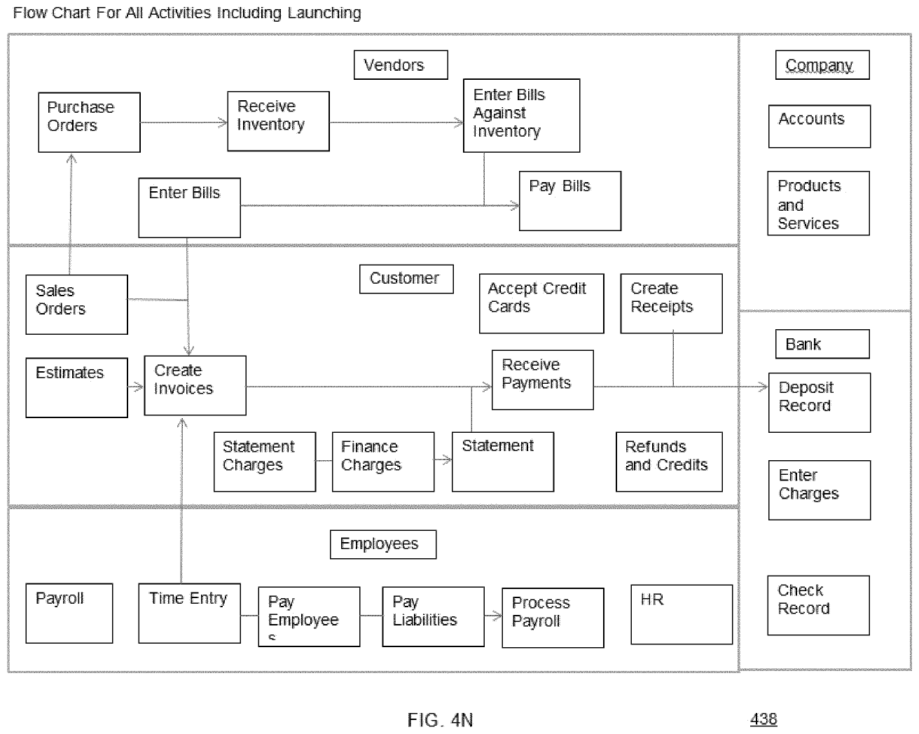

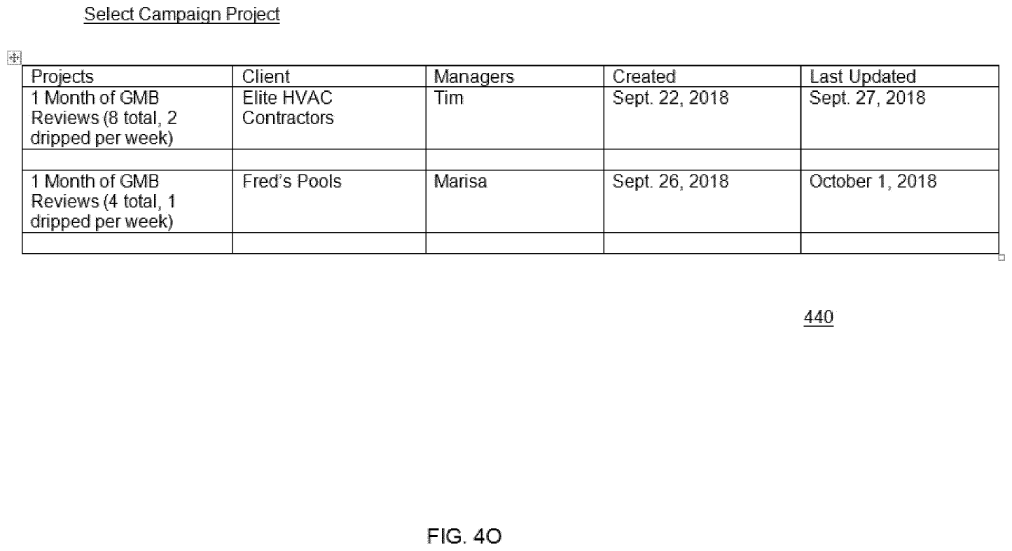

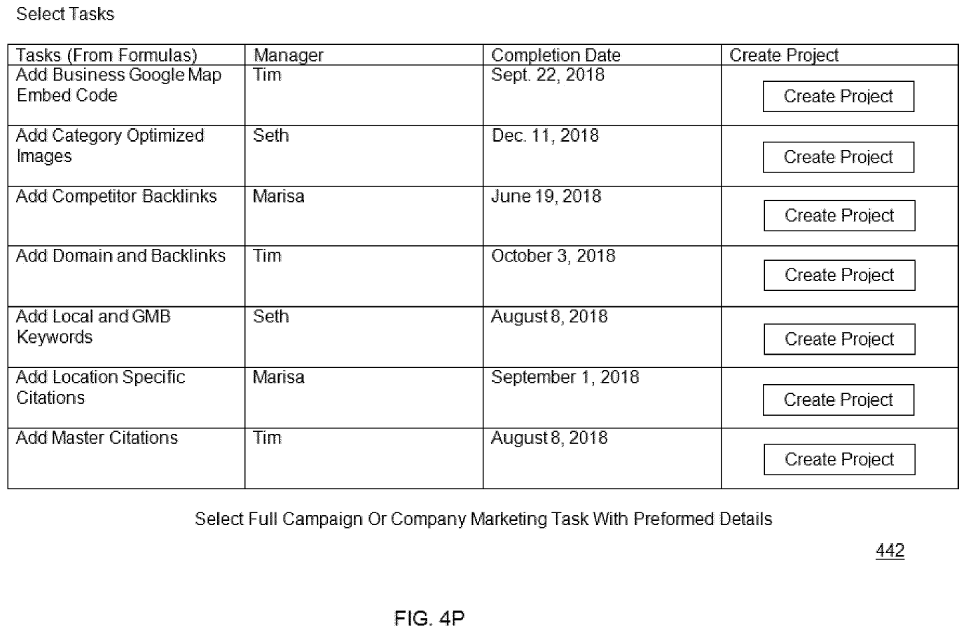

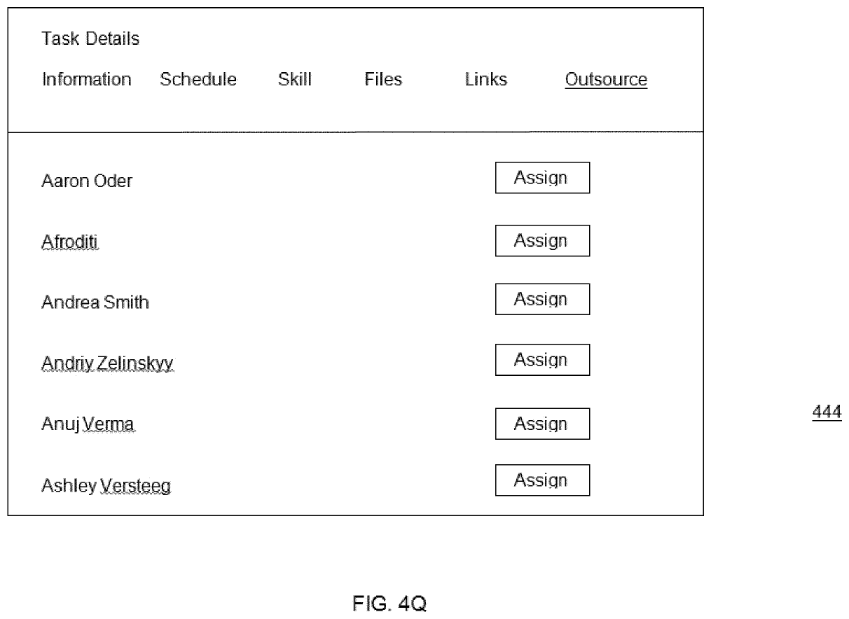

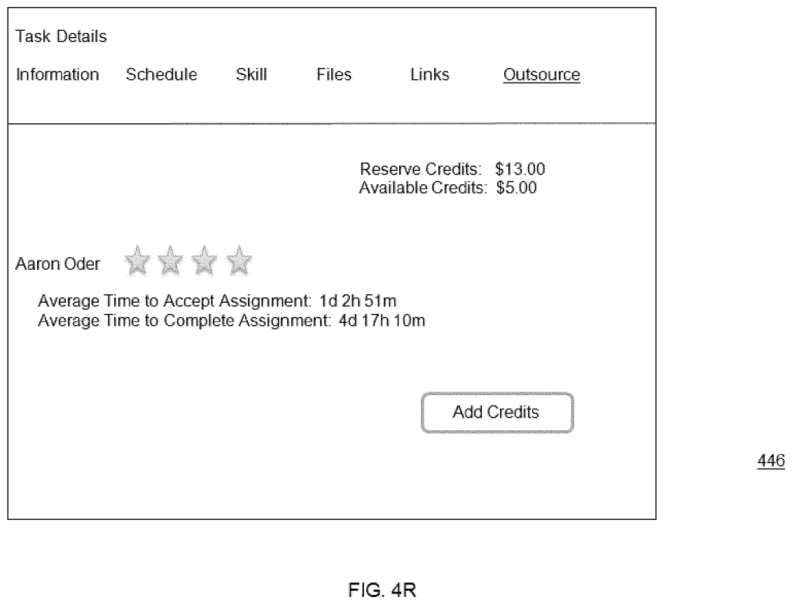

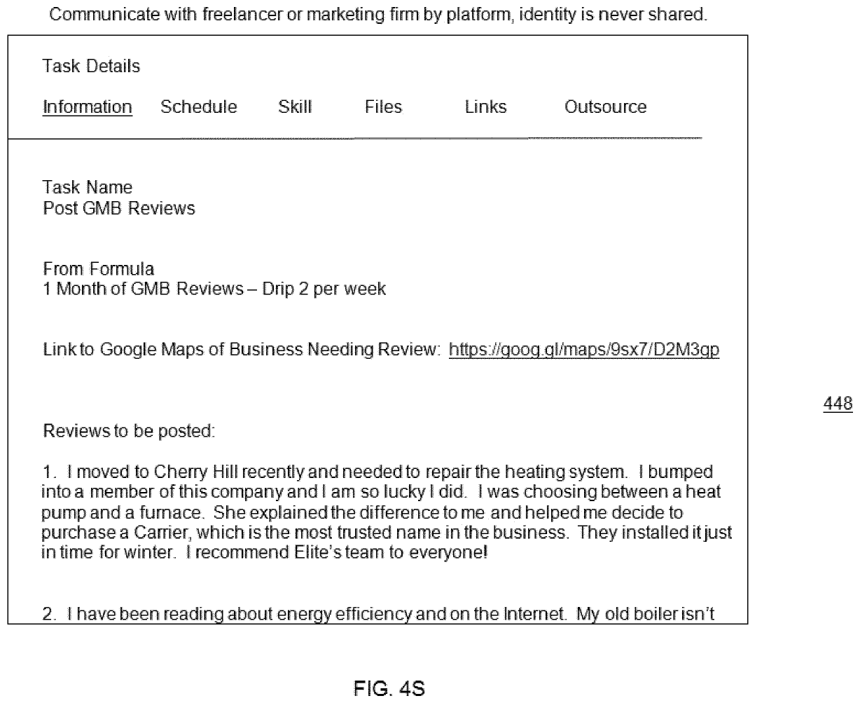

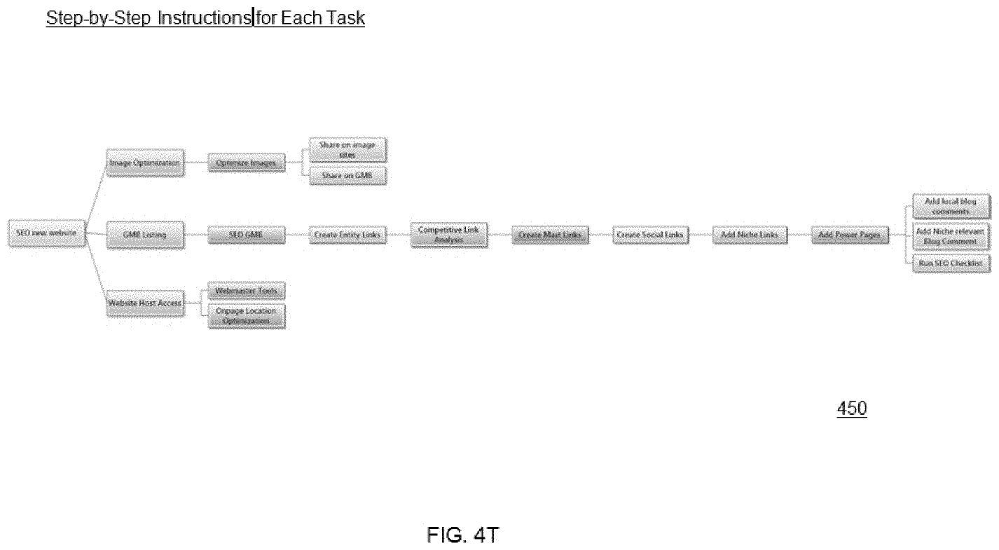

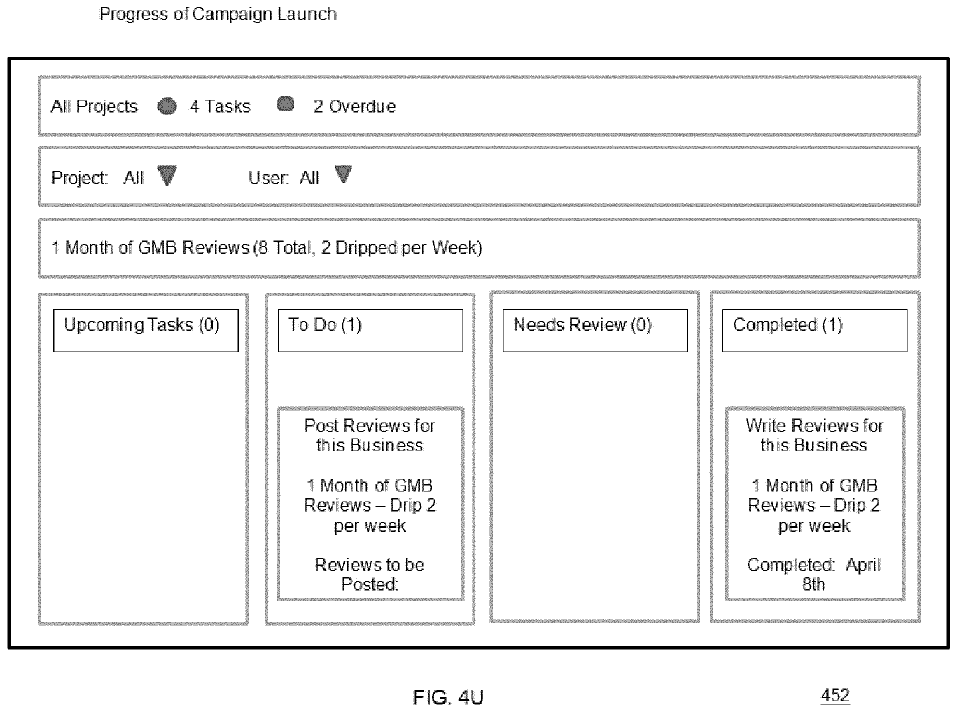

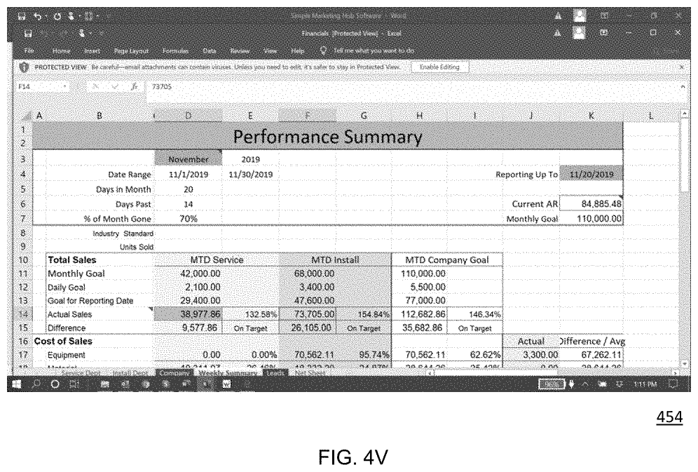

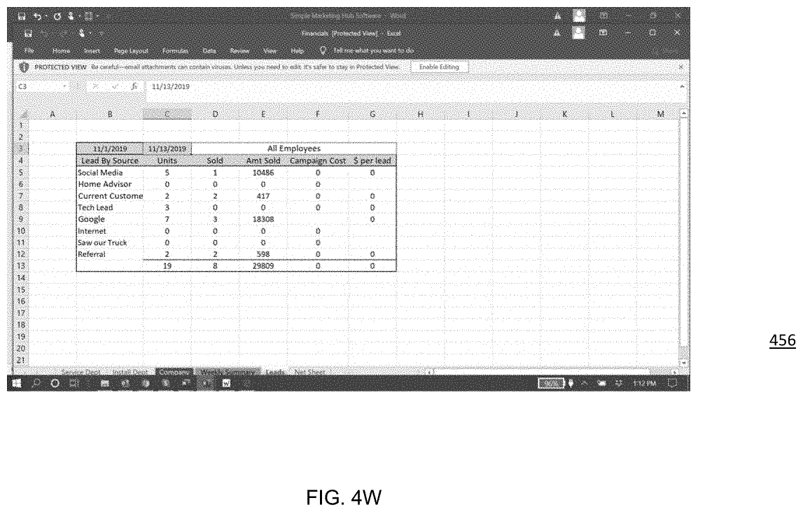

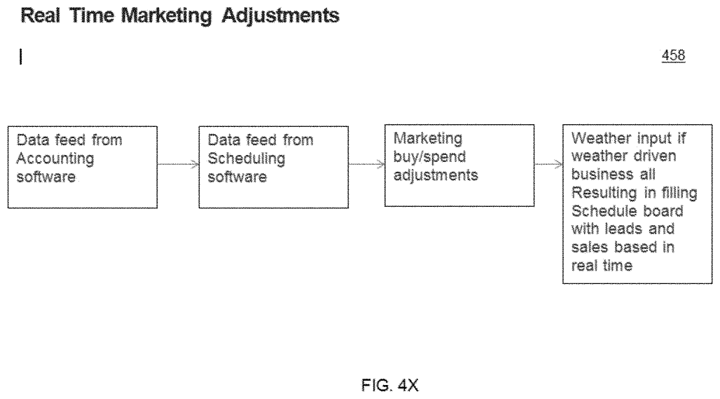

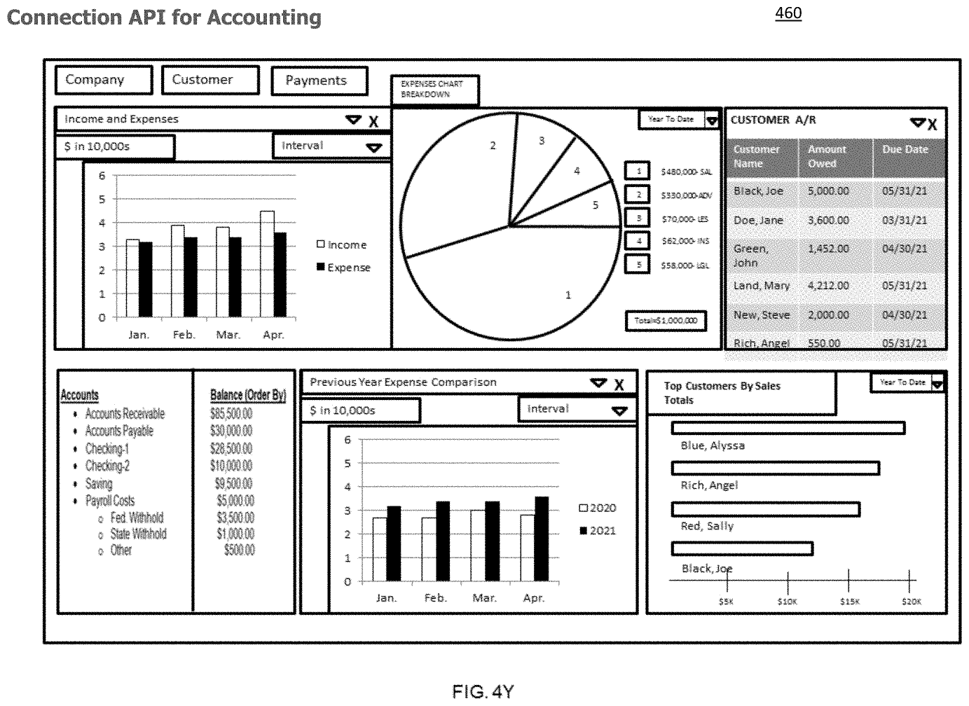

FIG. 4 is a high level flowchart for a method 400 for generating and monitoring a Marketing Plan for a purchaser company, according to an illustrative embodiment of the invention. A system such as the hub computer system 204 depicted in FIGS. 2 and 3 may be configured to generate interfaces in the steps of the process shown in FIG. 4. As shown, flowchart 400 generally includes the steps of generating interfaces to obtain data relating to budgeting 402, selecting 404, planning 406, launching 408, and reporting 410.

Generally, at step 402, the hub computer system may be configured to generate user interfaces for obtaining general budgeting information for the company seeking marketing services. In embodiments, the hub computer system may be configured to query the company for budgeting information by FIG. 4A depicts queries that may be presented in an interface to the company. As shown in FIG. 4A, the interface 412 may include queries for:
Determining the last year's gross sales.
Determining the Company's Desired percentage of Growth.
Determining the Marketing budget as a percentage of the total budget
Determine new sales goal for the year based upon gross sales and desired growth
Divide the new sales goal total by the number of months
Use the sales by month as a percentage of total to create a bench mark straight line for each month
Add or subtract dollars each month based on if the month is above or below baseline. If the volume is below, the budget increases the reciprocal of that months percentage.
   The budget and growth input into the interface can be performed for the company, department category or all-inclusive for any number of months.

The hub computer system may then include programming to generate a budget for the company. In an embodiment, that programming may include dividing the total budget by the number of months, and then the total sales by month as a percentage of total to create a bench mark straight line budget for each month.

At step 404, the hub computer system may be configured to generate user interfaces for selecting a budget to be spent for marketing services by the company. The system may be configured to add or subtract the dollars to each month based on if the month is above or below baseline. If the volume is below the budget increases the reciprocal of that months percentage. In addition, the hub computer system may include functionality to adjust each months budget, such as to increase the budget during known slow months. Exemplary tables or spreadsheets 414, 416 that may be generated based upon the budgeting information are depicted in FIGS. 4B and 4C. In an embodiment, the adjustment functionality may be provided on a spreadsheet 414 such as in FIG. 4B, or in embodiments a slider or other graphical element may be provided for adjusting particular fields, such as a monthly budget cap field.

As shown In FIG. 4B, on Line 1 budget is made by the month. On Line 2, the system selects the percentage of business by month over a 12 month period based on the selection of industry and location region. These numbers are requested and given by local distributors of products the business is selling by department. On Line 3, 100 divided by 12 gives a flat line even budget. Line 4 shows the difference short between line #2 and line #3. Line 5 depicts the difference over between Line 2 and Line 3. Line 7 is the adjusted percentage of 100 percent of marketing budget. Line 8 is the Total spend automated by the system based on input from upfront questions:
What is the percentage you want to budget in your marketing?
What was your income last Year?
What percentage of growth do you want this year?
   The system is configured to take 100 percent of the total and divide it by the monthly percentage for each month.

At step 406, the hub computer system may be configured to generate user interfaces for planning the advertising to be purchased with the marketing budget selected at step 404. The planning includes interface 418 for deciding where to advertise (See FIG. 4D), table 420 for identifying top level and individual marketing sources and tasks (FIG. 4E), and table 422 for developing a list of the individual(s) responsible for different marketing tasks (FIG. 4F). The planning may also include user interfaces 424, 426, 427 for obtaining details of how the marketing budget is spent on particular types of marketing (FIG. 4G, 4H). Further, the planning may include user interfaces for obtaining details regarding the leads, appointments, and sales that the company requires, usually per month. Still further, user interfaces 428 for generating scheduling for the various types of marketing buys, wherein the scheduling may be based on monthly gross sales, campaign performance, and budget (FIG. 4I).

In embodiments, the planning step may include user interfaces for setting performance triggers that activate marketing campaign increases or decreases depending on the sales and schedule. The triggers may be used to automate the marketing buys. The system is configured to update the marketing spends based on real-time dollar results to goals set on a daily level and trend budget setting before action is taken. User interfaces may be provided to set different marketing campaigns to be implemented based on sales and schedule targets, activity, and goals being achieved or not achieved.

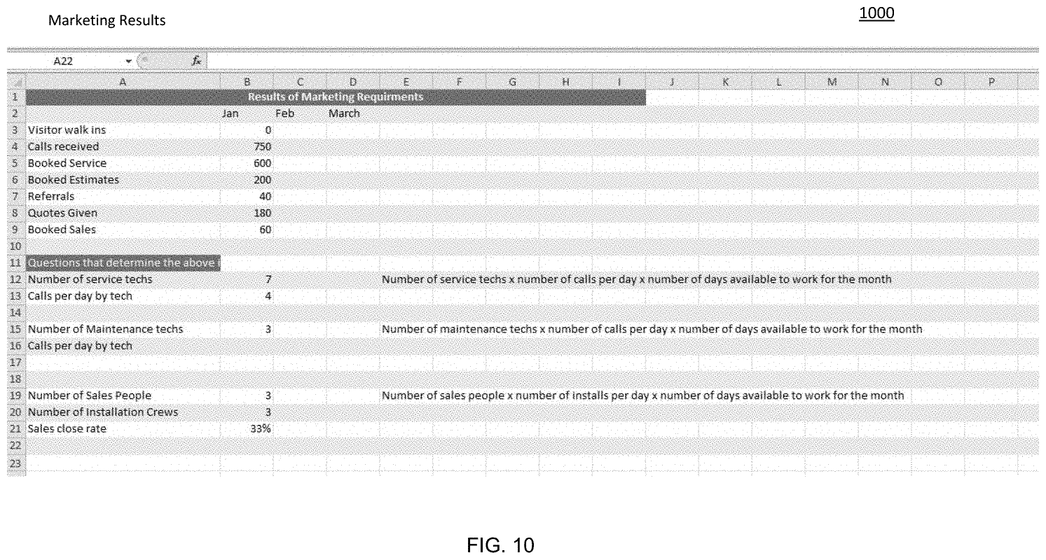

Planning may further include generation of interfaces 430 including a performance summary (FIG. 4J), which may be used to plan for marketing campaigns. In embodiments, the performance summary may also be used to implement triggers. The system may also be configured to generate a marketing strategies list 432 (FIG. 4K) that presents to the user all of the different types of marketing campaigns that may be implemented, from which a user can select to implement certain of the different types of marketing campaigns. Another user interface 434 may include a list of marketing tasks that the user may select to facilitate planning (FIG. 4L). Planning may also include user interfaces 436 for generating displays for tracking results of the marketing campaigns (FIG. 4M). FIG. 10 depicts an interface 1000 with a display which tracks the types of contacts that resulted from the marketing campaigns.

At step 408, the hub computer system may be configured to generate user interfaces for “launching” of the marketing campaigns developed using the planning user interfaces. Once a marketing strategy is agreed by and signed off by the responsible person in the planning step, during the launch step the creative elements for the marketing campaign are developed for all the different media/campaign types. In an embodiment, the sign off by the responsible persons may be completed two months prior to launch, with details regarding the campaign stored in a file waiting for launch. Once launch is started, each responsible party (identified in the planning step) is responsible for launching all of their responsibilities based on time triggers that are adjustable by company and vendor requirements.

During the launch step, the system may generate a flow chart 438 of all activities for the launch, as in FIG. 4N. The system is configured to provide each responsible party with interfaces for assigning tasks from a project to marketing companies or freelance individuals or entities. In an embodiment, the system may generate an interface 440 with different campaigns from which the responsible party may select. FIG. 4O. Then, the system may generate an interface 442 that depicts the individual tasks that need to be performed for the selected project. FIG. 4P.

In an embodiment, the hub computer system is configured to generate a comprehensive marketing campaign or to otherwise suggest tasks that should be performed to achieve the company's performance goals. The campaign could include a set of marketing tasks (e.g., seed positive reviews, respond to negative reviews, advertisements, etc.) and outlets on which the tasks should be performed (e.g., Google®, Clipper, Postcard, etc.). The generated marketing tasks may be based upon the marketing budget, the sales goals for the company, the expected performance of the marketing tasks based upon historical marketing information, and any other information provided to the hub computer system or any other information to which the hub computer system has access. The hub computer system is programmed with “formulas” or “recipes” that are used to implement the marketing campaign, which formulas specify the tasks (i.e., ingredients) to be performed to achieve the sales goals for the company. The formulas may be based upon historical marketing task performance data for the company or for other similar companies, which may be used to predict the particular results that can be expected based upon the implementation of particular marketing tasks and campaigns. In an embodiment, the hub computer system may include predictive models, which are trained using historical marketing information, geographic data, budget data, sales goals, performance data, and any other information provided to the hub computer system or any other information to which the hub computer system has access. After the predictive model is trained, it may be used to process geographic data, budget data, sales goals, performance data, and other data to generate a formula or recipe of marketing tasks needed to be performed to achieve a sales goal for a company.

By way of example, the system may be programmed with a specific predictive application, namely, a forecast model, which operates on metric value prediction, estimating numeric value for new data based on learnings from historical data, and which model receives multiple input parameters including those parameters described herein above. This particular model may be used, in contrast to other such models such as a classification model, clustering model, and/or outlier/anomaly model. In an embodiment, thresholds are set for specific values (e.g. dollar values or number of items sold) of the marketing budget and proposed sales goal amounts, in correlation with external data sets reflecting performance expectations of the specific marketing task items, and further based upon historical marketing information. The system utilizes the predictive model as part of a feedback loop in order to control the implementation and/or activation or termination of specific actions, according to a programmed risk tolerance/risk aversion table based on specific parameter values (if you want to add anything associated with specific parameter values here, go ahead . . . “such as X, Y, and/or Z”).

As used herein, the phrase “predictive model” refers to any of a class of algorithms that are used to understand relative factors contributing to an outcome, estimate unknown outcomes, discover trends, and/or make other estimations based on a data set of factors collected across prior experience such as results from prior marketing tasks and campaigns. A predictive model might also refer to, but is not limited to, methods such as ordinary least squares regression, logistic regression, decision trees, neural networks, generalized linear models, and/or Bayesian models.

For each individual task, interfaces may be generated depicting available marketing companies capable of performing the task. Interfaces 444 may also show freelancers (FIG. 4Q) available to perform the task, and interfaces 446 that describe the task details (FIG. 4R). In an embodiment, the interfaces for selecting marketing companies or freelancers to perform tasks may include filters that allow marketing companies and freelancers to be shown according to different factors. For example, the filters may be selected to show whether marketing companies or freelancers that have flat rate marketing management, that have project based marketing fees, that have performance percentage on spend, based upon cost per lead, and based upon cost per sale. Additional filters may be based upon price, reliability, delivery time, ROI (return on investment), cost per sale, and key performance numbers. Other factors considered by the system for freelancers may include: (1) Success rating; (2) Payment history; (3) Completion success; (4) Type of company; (5) Payment of project or hourly fee or best bid; (6) Age of business; (7) Amount of work they will provide; (8) Type of work they do; (9) Quality of their work; (10) Fluency of Language; and Location of business. Factors considered by the system for marketing companies may include: (1) Success rating; (2) Number of jobs done; (3) Are they independent or under a larger firm; (4) Price of project or hourly fee; (5) Age of business; (6) The skill level and test passed; (7) Samples of their work; (8) fluency of Language; and (9) Location of business.

During the launch step, the system is also configured to provide interfaces 448 for communicating with a selected marketing company or freelancer, such as shown in FIG. 4S. In embodiments, the communication may be anonymous, such that one or both of the identity of the company or the responsible party for the particular task is not revealed to the marketing company or freelancer. The hub may be configured to generate interfaces for both the company and the marketing company or freelancer. The interfaces may include, in addition to communications interfaces, interfaces for identifying the tasks, files for the tasks, and details for the tasks, to the marketing company or freelancer. These tasks and details were previously generated using the interfaces during the planning phase. In embodiments, the details may include an overview of all of the tasks, as well as step-by-step details 450 of the tasks for the marketing company or freelancer to perform. FIG. 4T.

During the launch step, the system may also be configured to generate user interfaces 452 that depict the progress of campaigns and individual tasks within each campaign. FIG. 4U. This allows both the company seeking services and the marketing companies and freelancers to keep track of progress.

At step 410, the hub computer system may be configured to generate user interfaces for “reporting” relating to the effectiveness of marketing campaigns developed using the planning user interfaces and implemented by the launch user interfaces. For example, the system may be configured to generate a performance summary spreadsheet 454 (FIG. 4V) which includes monthly statistics including total sales, monthly goal, daily goal, goal for reporting date, actual sales and the difference to goals, and cost of sales. The performance summary may depict marketing updated spends based on real time dollar results, to goals set on a daily level and trend budget setting before action is taken. The performance summary may be used to set triggers for different marketing to be implemented based on sales and schedule targets, activity, and goals being achieved or not achieved. The interface 456 may also display data concerning leads by source, and, related data. (FIG. 4W)

In the embodiment in which a performance summary spreadsheet is generated by the system, the sales data must be provided to the system so that the spreadsheet may be generated. The hub system may be configured to generate user interfaces that provide the user company the option to automatically or manually provide the sales data. When the user selects the automatic option, the user may be presented with an API to configure the automatic provision of sales data from the company's sales data system to the hub. When the user selects the manual option, the hub system may be configured to prompt the user for the sales data periodically. In embodiments, the hub system may receive data feeds from the company's accounting (sales) software, scheduling software, and a weather feed, which data together may be used by the hub system to fill a schedule board with leads and sales based in real time data 458. FIG. 4X.

As noted, the hub system may be configured to receive a data feed from a company's schedule software. A company may use scheduling software to provide for labor load management, which is one of the keys to a profitable business. For example, a service industry may use scheduling software to try to optimize its labor usage at 100%. While 100% labor usage is difficult to attain because of travel time and service demand changes, it is a goal to optimize the labor usage.

The hub system may use the scheduling software data, and the information about available labor during different times, to optimize the advertising and marketing. For example, a company may typically have a stable labor force, but may have busy seasons and slow seasons. A marketing plan that accounts for these busy and slow seasons may be used to optimize labor usage. For example, during slow periods, marketing may be increased based on demand of the hourly schedule, with a 3 day view. On the other hand, if the company is a company whose workload is weather driven and a heat wave is coming in three days, the company could avoid surplus business above the level of its labor force capabilities by not advertising before the heat wave, because it is anticipated that work will naturally come in to the business during the heat wave. By way of further example, a roofing company may not advertise within 3 days of an expected rain storm, because work will naturally come in and excess work above the labor capabilities is undesirable. During these times demand-based companies do not need additional marketing and their brand and customer base keeps them at capacity with all the overtime the workers can handle. For shoulder times and slow times the company can use the hub computer platform to create and launch marketing campaigns with specials and incentives to get customers to take action and buy now. The companies scheduling software API will communicate with the platform and constantly show the labor capacity of the schedule for the week and beyond. The use of the scheduling data allows the hub computer platform and users to constantly adjust marketing to high value targets across all marketing channels, vendors, and platforms as constantly needed.

In a further embodiment, the hub computer platform may include a weather module that is linked to an Internet-based weather application. The weather module may be configured to receive a feed of weather data from a network based (e.g. Internet-based) weather application including one or more of temperature data, wind data, and precipitation data, or the weather module may be configured to monitor weather data displayed or otherwise provided by the Internet-based weather application. The weather data may typically include current local weather data as well as projected (e.g. two, five, seven or ten day) weather forecasts for a user selected region.

The hub computer platform may use weather data received or monitored by the weather module to activate one or more software triggers adapted to launch or delay the launch of marketing campaigns. The hub computer platform may provide graphical interfaces for setting weather-based triggers using data from the weather module. For example, as noted, a roofing company may not want to advertise within 3 days of an expected rain storm, because work will naturally be generated due to the storm and excess work above the labor capabilities is undesirable. The hub computer platform may provide a user with graphical interfaces that allow the user to set a weather-based trigger for delaying the launch of marketing campaigns based upon parameters of weather data. For example, if the company is a roofing company, the company may use the interfaces for setting a weather-based trigger to cause a timing delay in a scheduled launch of one or more marketing campaigns if, for example, precipitation over a certain threshold amount is expected over a select time interval, such as one-half inch of rain (or other quantitative physical data parameter) each day for 3 consecutive days (or user/device selectable period) projected within a given geographic region. Alternatively, the program interfaces may allow setting of weather-based triggers based upon time-based averages for select time intervals, such as an average of one-half inch of rain over three consecutive days. In another alternative, the interfaces may allow the user to set weather-based triggers based upon a combination of different weather parameters, such as a trigger to delay the launch of a campaign based upon a three day average of a quarter inch of rain in combination with three days in which sustained wind gusts are predicted to be over 40 mph. In embodiments, probabilistic or predictive analyses may also be applied to the received weather data to determine whether a weather-based trigger condition is likely to occur.

By way of further example, weather-based triggers may be used to cause to expedite the launch, extension, or shortening of marketing campaigns, rather than simply the delay of campaigns. For example, a company in a retail industry, that is located in a town center (rather than in a mall), may have a marketing campaign planned for a three-day weekend. However, the company is aware that if it rains during the three-day weekend, sales will normally be lower due to the adverse weather. The company may set a weather-based trigger to prioritize or re-schedule launch of the campaign earlier than initial scheduled, to take advantage of anticipated clear weather conditions ahead of the estimated rainy-three day weekend. Alternatively, the company may set a weather-based trigger to maintain the current start date for the campaign, but extend the campaign for three days after the rainy three-day weekend when the weather is clear. In contrast, a mall retailer may recognize that mall sales increase during hot and rainy three-day weekends because people are more likely to frequent malls to take advantage of air conditioning and rain cover (as compared to a main street retailer), and may set triggers to reduce the length of campaigns (or to modify parameters of the campaign to, for example, lower a discount available during the campaign) when such conditions are predicted. Marketing campaigns may even be permanently eliminated due to weather conditions, such as when a week-long weather event like a hurricane is expected. Any combination of weather parameters may be used to set weather-based triggers that launch, delay, extend, or otherwise modify marketing campaigns.

In order to implement the launch, delay of launch, extension, or elimination of a marketing campaign, the hub computer platform is configured to identify relevant campaigns that may be affected by the occurrence of a weather-based trigger. In embodiments, this search is automated, with the hub computer platform configured to automatically perform a search of its database for pending marketing activities and campaigns generated for the user/company that set the weather-based trigger. Typically, such campaigns should be noted on a calendar of campaigns generated by the hub computer platform, and the hub computer platform is configured to search the calendar. However, the hub computer platform may also be configured to search its database of marketing activities relating to a company to identify marketing campaigns that are not on the calendar, such as last minute campaigns that are in progress that have not been completed and placed on the calendar. The system may also implement artificial intelligence (AI) algorithms or other automated processing based on marketing content using weather-related words (e.g. hot, cold, cool, mild, rain, snow, sun, flood, drought, etc.) and weather-associated words (e.g. hike, swim, walk, ride, enclosed, indoor, outdoor, etc.) and context related information to assess whether select marketing campaigns are to be subject to weather monitoring and time-based trigger actions. After the relevant campaigns have been identified, parameters of the campaign may be modified based upon the instructions configured by the user for the applicable weather-based trigger. For example, in an embodiment a timing clock associated with the launch of a campaign may be modified based upon determination of the occurrence of the weather-based trigger. The hub computer platform may also be configured to identify potentially relevant marketing campaigns that occur close-in-time before and after the weather-based trigger, to determine whether modification of such campaigns is required.

In further embodiments, the hub computer platform may be configured to generate an alert in relation to weather-based trigger conditions. For example, the alert may correspond to the identification of the potential occurrence of a weather-based trigger condition previously set up by the user, and may provide information to the user of the weather-based trigger and/or the marketing campaign modification that is being implemented by the hub computer system based upon the weather data. In other embodiments, the hub computing platform may also be configured to transmit, with the alert, user-selectable buttons to either (1) confirm the marketing campaign modification, (2) adjust the marketing campaign modification, or (3) ignore the weather event and allow the marketing campaign to be launched without modification. As noted, the hub computing system is configured for the user to identify responsible parties for different components of the marketing campaigns. In an embodiment, the alert is transmitted to the person responsible for the timing of marketing campaigns, and may generally be transmitted by email or text message. Implementation of the instructions for the weather-based trigger is thus based upon a decision provided by the user responsive to the selections provided by the alert.

Thus, implementation of the weather module in the hub computing platform permits the system to leverage third-party weather data provided by Internet-based weather applications. The weather data and weather parameters may be fed to the weather module via an Internet feed, and the hub computing platform provides graphical interfaces that permit the user to configure weather-based triggers to modify campaigns based on particular weather parameters, thresholds, and averages. The integration of the weather-based data and weather-based triggers into the hub computing platform provides for automatic timing adjustment of campaigns, and may provide for automatic adjustment of campaign parameters such as length of campaign and discounts available for a campaign, based upon the Internet-based weather data received by the weather module.

As noted, in embodiments the hub system is configured to receive data 460 directly from the company's accounting software. A connection API (FIG. 4Y) may be implemented for that purpose.

Performance of marketing companies and freelancers is also tracked by the hub system. The performance information may be provided in user interfaces to companies seeking marketing services. In an embodiment, the better a marketing company or freelancers numbers and performance are, the higher they are on a list of available companies or freelancers for performing marketing services, unless a filter is used to perform a specific search.

The marketing hub computer platform is a collaborative build. It may start with top level list and details for the company side. The process is the same for a company looking for Marketing firms. In the same way Marketing firms would use the system to find freelancers or other producers to get the projects done. The more the system is used the more valuable it becomes. The more users hire and building history and projects, the more selection companies will have to select from. In an embodiment, the business model is free to front end users and the hub is paid a percentage of buy for paid services. A software hub allows companies to use the platform for all of their marketing and tracks real time results. The software will have API's for scheduling and accounting to make sure goals are always met to the best of their ability. Marketing companies performance is always tracked with Key Performance financial numbers. This allows companies seeking marketing services to select marketers with less risk and greater results. Real time connections allows companies a daily weekly and monthly view of marketing and sales goals and automates the implementation of additional marketing spends or different campaigns as needed. Combining all marketing companies in one hub simplifies trying to find the right marketing firm or individual to a company's before the company needs them, then the hub implements all the marketing process. In an embodiment, the hub does not any marketing.

In the planning step, the system may be configured to generate interfaces for setting triggers for different campaigns or different media types to be implemented. The hub system is configured to compare the triggers to the performance summary in real time to assess which types of campaigns should be implemented to react to particular types of sales and performance data, as specified by the triggers selected by the company. Thus, the spends by the marketing provider can be based upon real time dollar results and goals set on a daily level, and trend budget setting before actions are taken, based upon the triggers. Triggers can be set for different marketing activities to be implemented based on sales and schedule targets, and whether certain activity and goals have been achieved or not achieved.

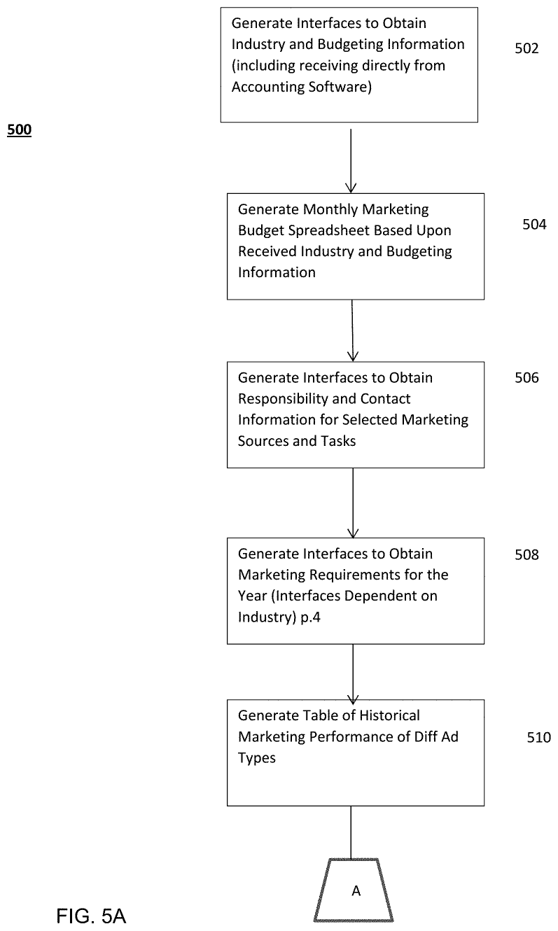

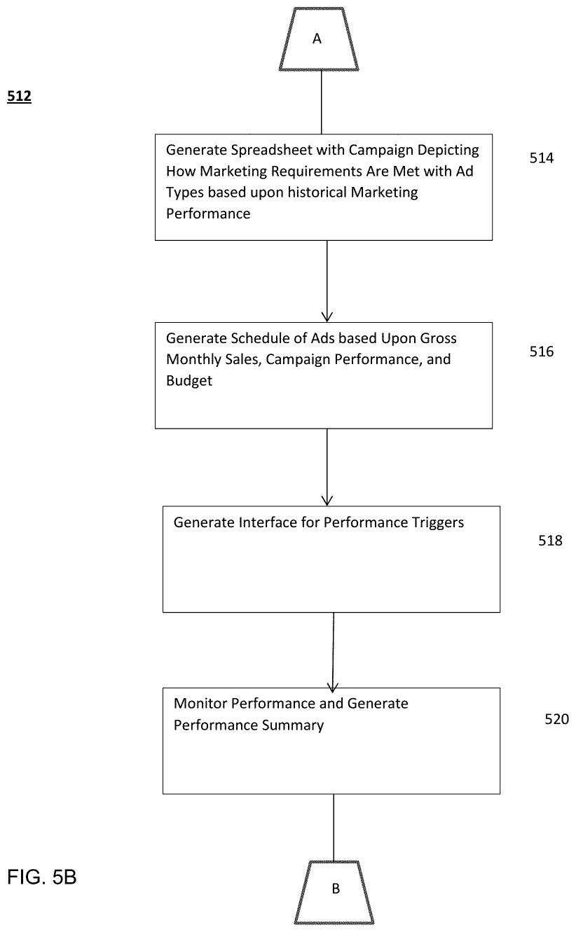

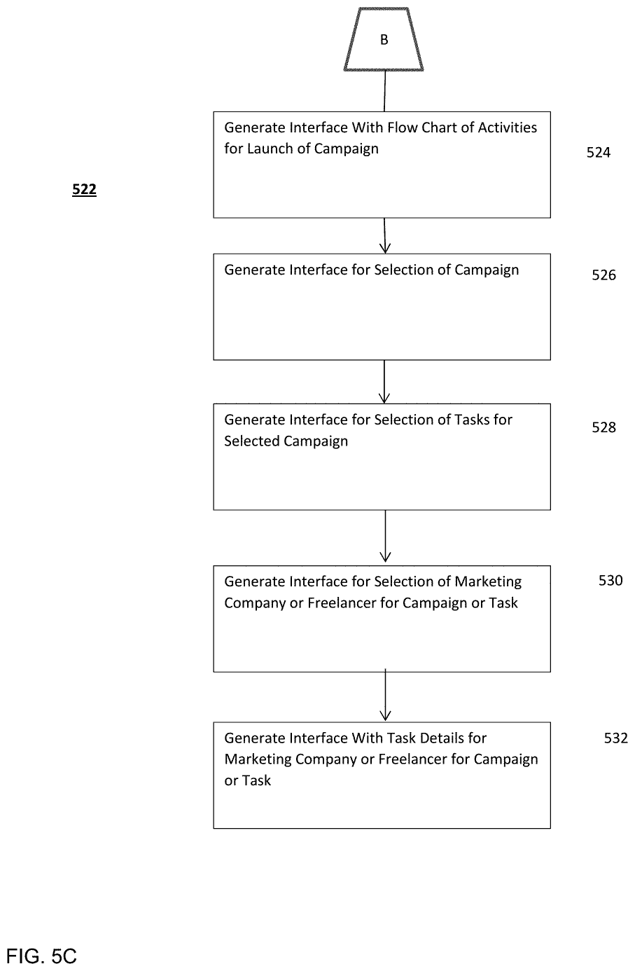

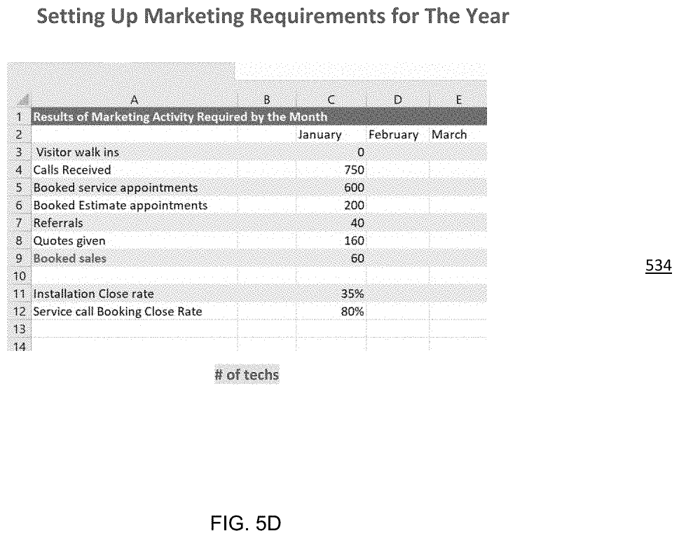

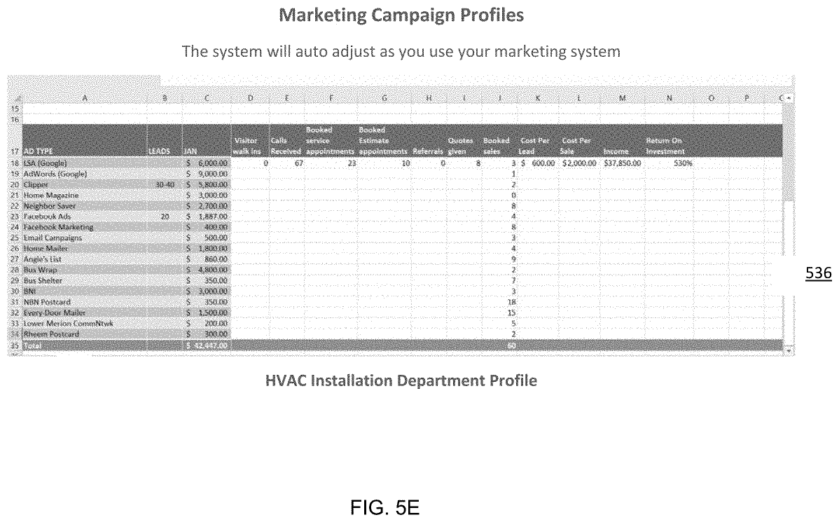

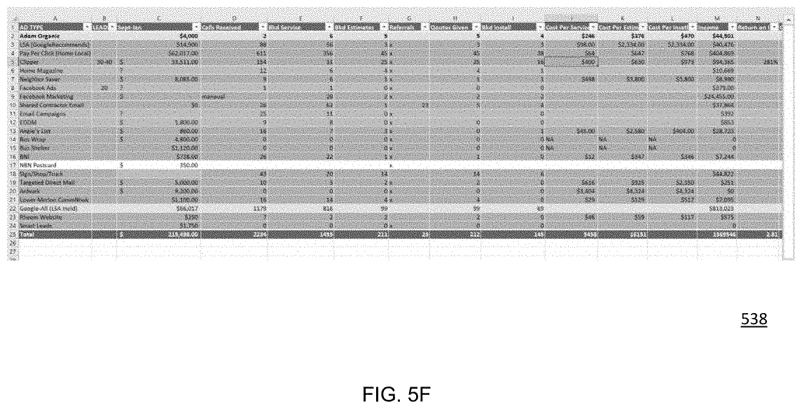

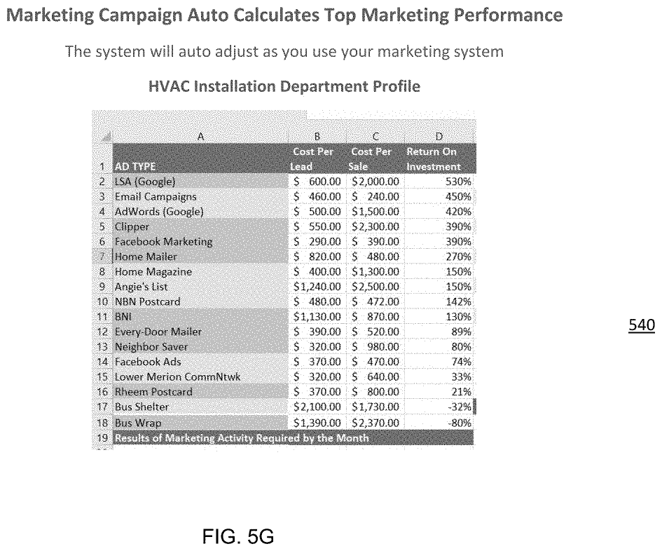

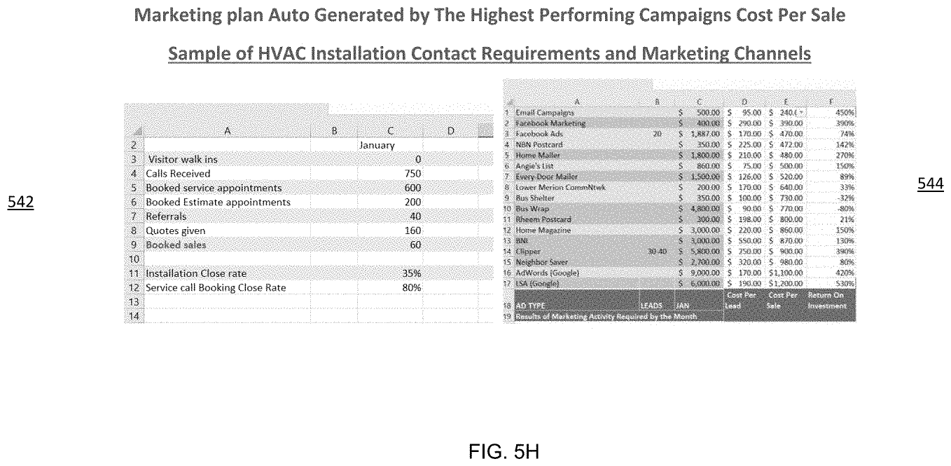

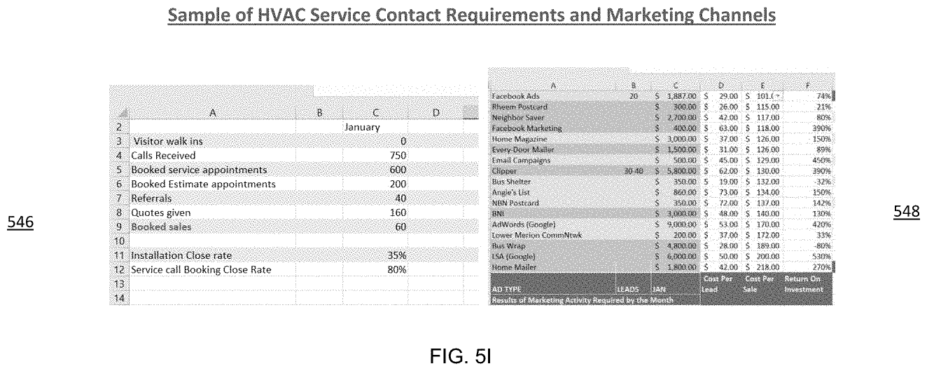

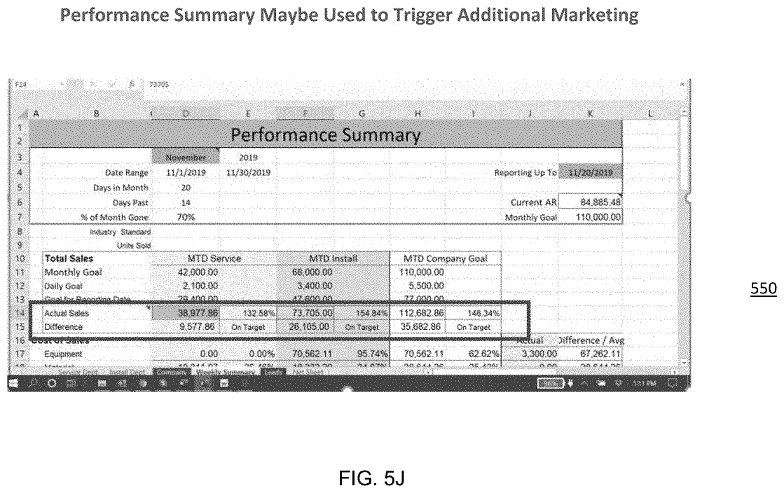

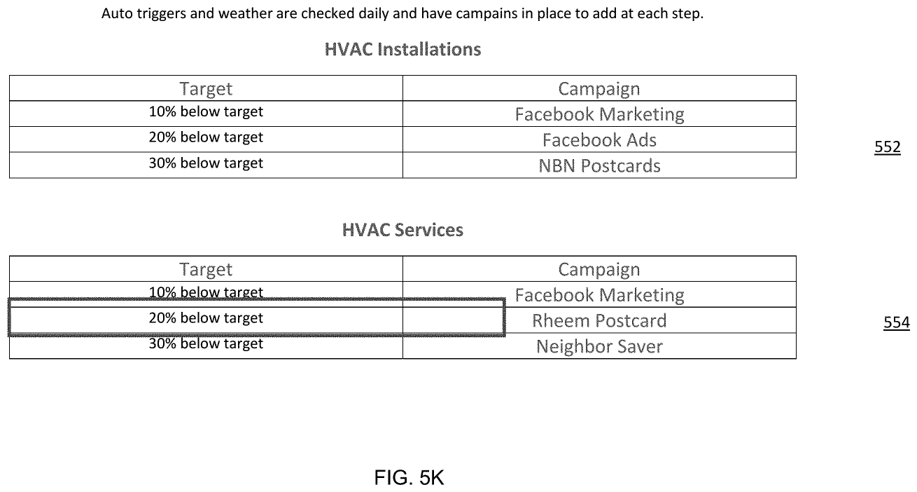

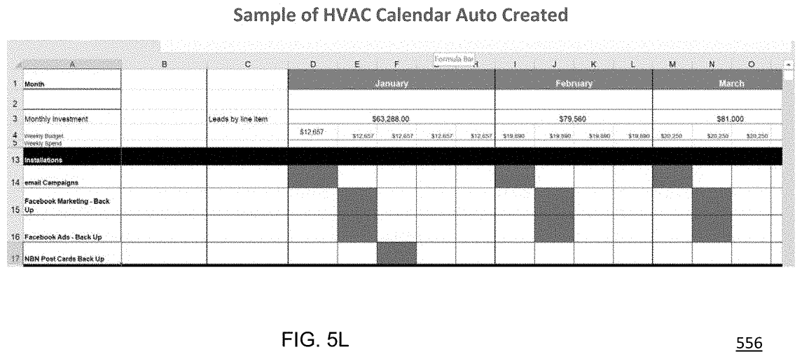

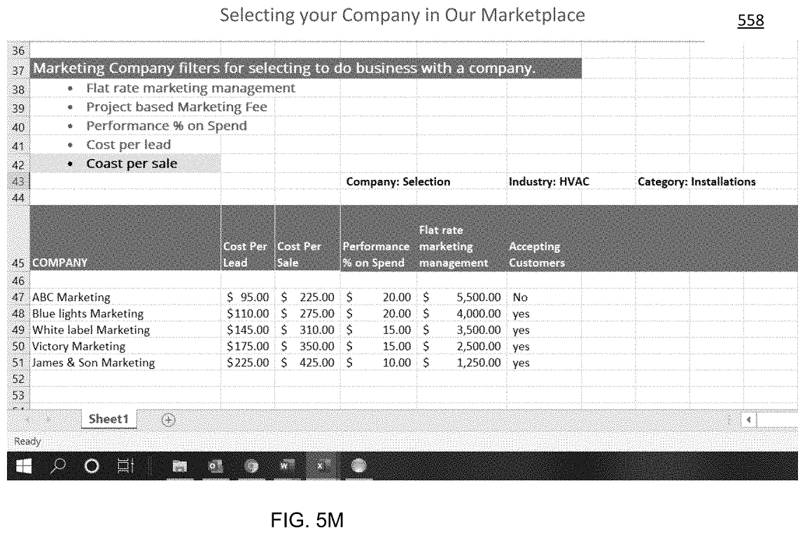

FIGS. 5A-5C depict a flowchart for a method 500 for generating a Marketing Plan for a purchaser company, according to another illustrative embodiment of the invention. A system such as the hub computer system 204 depicted in FIGS. 2 and 3 may be configured to generate the series of interfaces generated by the process shown in FIGS. 5A-5C.

As noted in the Background, companies often do not have the expertise to know what kind of marketing they require or to generate marketing campaigns for their business. The flowchart of FIGS. 5A-5C provides a process, implemented on a hub computer platform, that facilitates the provision of information by companies that is needed to develop a marketing plan for each company. The configuration of the hub computer platform to both generate interfaces to request particular types of information, and to provide for receipt of data via an API that interfaces with each company's accounting, marketing, and sales systems, provides for a specific integration of technology that goes beyond merely computerizing marketing. Further, the configuration of the hub computer platform to process historical data, as well as budgeting and sales data, to identify ad types and a calendar for launching campaigns to meet the sales and/or profit needs of each company also provides for a specific integration of technology that goes beyond merely computerizing marketing. Further still, the configuration of the hub computer platform to generate interfaces to facilitate the participation of select marketing companies, business consultants, and/or freelancers in the hub computer platform according to, in one embodiment, a predetermined selection criteria, including for example, particular technological interface tools, screening systems, cybersecurity capabilities, credentials, and protocols, to offer their services on the hub computer platform, and to provide a production center for communication and the development of marketing campaigns by the marketing companies, business consultants, freelancers, and the companies seeking marketing or business services.

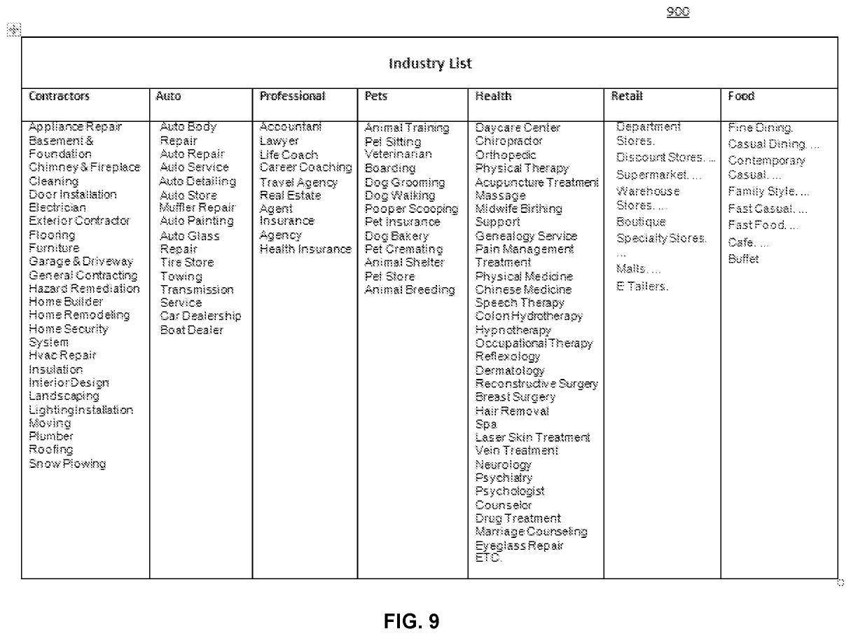

Steps 502 and 504 generally correspond to the budgeting step 410 of FIG. 4. At step 502, the system may be configured to generate interfaces to obtain marketing model information such as business type, industry type, and location information. In embodiments, the business type may comprise one of five different types:
Seasonal—Work three seasons and off one season
Weather driven—Peaks and valleys based on weather
Retail Store—Goods & Appeal
Professional—Accounting and Medical type services
Consistent—Fast food
   In relation to these business types, the hub computer platform may be configured to generate queries to elicit information from the company. Exemplary queries include:
Is your business seasonal? If so, what are your high and low seasons?
Is your business weather driven? If so, is their months this is affecting business high and low times?
List your months by busiest to slowest.
   The hub computer platform may also be configured to generate an interface which includes an industry list 900 for consideration by the user company, such as the list shown in FIG. 9. The hub computer platform may be configured to provide the entire list to the user, or to first provide the top level categories—Contractors, Auto, Professional, Pets, Health, Retailers, and Food—to the user, and then provide the subcategories to the user after selection of the top level category that applies to the user's company. In addition, the hub computer platform may be configured to first generate, responsive to selection of a particular industry, particular queries to further refine the information obtained about the company. The industry list can be updated and refined as marketing for additional types of businesses is made available. The location information may be selected from a map shown on the interface.

In embodiments, the hub computer platform system may generate user interfaces for obtaining budgeting information. As described in relation to FIG. 4A, queries that may be presented in an interface to the company. As shown in FIG. 4A, the queries may include:
Determining the last year's gross sales.
Determining the Company's Desired percentage of Growth.
Determining the Marketing budget as a % of the total budget
Determining the Convert to new sales goal for the year.

The hub computer system may also generate an interface for obtaining marketing location by month information. The interface may include a sliding scale to override each month.

The hub computer system may include programming to generate a budget for the company. In an embodiment, that programming may first include dividing to total budget by the number of months. In an embodiment, the hub computer system may then be configured to use the business type by industry and the location for sales by month input as a percentage of total to create a bench mark straight line for each month. In addition, the hub may be configured to add or subtract the dollars to each month based on if the month is above or below baseline. If the volume is below the budget increases the reciprocal of that months percentage.

In an embodiment, the budget is made by the month. The hub system may be configured to select the percentage of business by month based on the selection of industry and location region. These numbers may be requested and given by local distributors of products the business is selling by department. Dividing the yearly budget by 12 provides a flat line monthly budget.

In further embodiments, the user interface may include instructions for providing budgeting information directly from accounting software of the purchasing company computer system. In addition, the hub computer platform may store data indicative of benchmarks for sales volume by industry, which data may also be used to generate the sales goals and marketing budget for the company.

At step 504, the system may be configured to generate a user interface depicting a Monthly Marketing Budget Spreadsheet Based Upon the received Industry and Budgeting Information. An exemplary user interface 414 generated at step 504 is depicted in FIG. 4B.

Steps 506 to 520 generally correspond to the selecting (420) and planning (430) steps of FIG. 4. At step 506, the system may be configured to generate user interfaces for obtaining Responsibility and Contact Information for Selected Marketing Sources and Tasks. Exemplary user Interfaces 420, 422 generated at step 506 are depicted in FIGS. 4E and 4F.

At step 508, the system may be configured to generate user interfaces for Obtaining Marketing Requirements for the Year (Interfaces Dependent on Industry). An exemplary user interface 558 generated at step 508 is depicted in FIG. 5M. As shown in FIG. 5D, the spreadsheet may include categories of types of business generated for a particular industry. In the example of FIG. 5D, the particular industry is able to obtain business through walk-ins, calls, booked services, booked estimates, referrals, quotes given, and booked sales. In addition, in this particular type if industry, the number of maintenance technicians, service technicians, and sales people enables the hub system to determine a maximum number of services are theoretically possible. The hub system may also be configured to generate different marketing requirements interfaces based upon different types of industries. Thus, for example, a retail business would not have technicians, but would have sales people and perhaps installation people, so the interface would include that appropriate information rather than maintenance technician information. Thus, the hub computer system will generate appropriate interfaces for the user company, and the company will complete the interface to identify the types of campaigns it wishes to implement. The hub system can help determine how many of each business generation category is needed to attain the budgeting and growth goals for each month.

At step 510, the system may be configured to generate a user interface depicting a Table of Historical Marketing Performance of Diff Ad Types. Exemplary user interfaces 536, 538 generated at step 510 are depicted in FIGS. 5E and 5F. As shown in both FIGS. 5E and 5F, the hub system is configured to generate a marketing campaign profile that shows the different ad types that are used for marketing. If details are not known, the business can estimate its spend, the number of booked sales, cost per lead and cost per sale by campaigns. Also, many business are not aware of the different types of ad types, and providing these types to the business in an interface makes them aware of potential missed marketing opportunities. As shown in FIG. 5E, for a particular type of business, the ad types may comprise: 1) LSA (Google®); (2) Email Campaigns; (3) Adwords (Google®); (4) Clipper; (5) Facebook® Marketing; (6) Home Mailer; (7) Home Magazine; (8) Angie's List®; (9) NBN Postcard; (10) BNI; (11) Every-Door Mailer; (12) Neighbor Saver; (13) Facebook® Ads; (14) Local Neighborhood network; (15) Postcard; (16) Bus Shelter; and (17) Bus Wrap.

Interface 538 of FIG. 5F also depicts the results from each type of ad type, also providing the company with valuable information concerning what types of ads generate what types of business and what types of ads are more successful than other types of ads. This information may assist the user company in planning additional marketing campaigns, and may help the company identify and complete the marketing requirements for the company depicted in FIG. 5D.

At step 514, the system may be configured to generate a user interface depicting a Spreadsheet with Campaign Depicting How Marketing Requirements Are Met with Ad Types based upon historical Marketing Performance. FIG. 5G depicts a display 540 that provides even more detail to the company concerning the effectiveness of the various ad types, and may include information such as cost per lead, cost per sale, and return on investment. This provides valuable information to the company that the company may not otherwise be aware of if not generated in an interface by the hub system. As noted, in order for the system to generate interfaces such as shown in FIG. 5G, the sales data must be provided to the hub, either automatically through an API or manually.

At step 516, the system may be configured to generate a user interface depicting a Generate Schedule of Ads based Upon Gross Monthly Sales, Campaign Performance, and Budget. Exemplary user Interfaces 542, 544, 546, 548 generated at step 516 are depicted in FIGS. 5H and 5I. The schedule of ads shown in FIGS. 5H and 5I is based upon the monthly sales information, campaign performance information, and budgeting information previously provided to the hub computer system via the previously discussed user interfaces provided to the company seeking marketing services.

As shown in FIG. 5H, the hub computer system generates extremely detailed data regarding an overall marketing campaign for HVAC installation, with different ad buys that are configured to fulfill the business requirements of the company. Thus, as shown in FIG. 5H, the interface 542 depicts the number of different types of contacts required, such as walk in visits, calls, booked service appointments, booked estimate appointments, referrals, quotes given, and booked sales. In order to meet the sales requirements, 200 estimate appointments, 160 Quotes, and 60 install sales are required. The FIG. 5H interface 544 shows 17 different types of campaigns that are planned, including the cost per lead, cost per sale, and return on investment for each of the different types of campaigns. As stated in FIG. 5H, with the knowledge that cost per lead is $95 and cost per sale is $240, in order to get 200 leads to get 60 sales, a budget of $19,000 emails campaigns is determined. In an embodiment, the monthly spend is determined on a per department performance basis, for the company marketing plan.

FIG. 5I shows an overall marketing campaign for HVAC Service, with different ad buys that are configured to fulfill the business requirements of the company. Notably, the system determines that different types of campaigns are more effect for HVAC Service than for HVAC Installation. The requirements for HVAC Service to meet its sales goals is 750 calls and 600 appointments. The hub system determines that with a known cost per lead of $29 and cost per sale of $101, a budget of $21,750 to Facebook® Ads is needed to get 750 calls to get 600 service appointments.

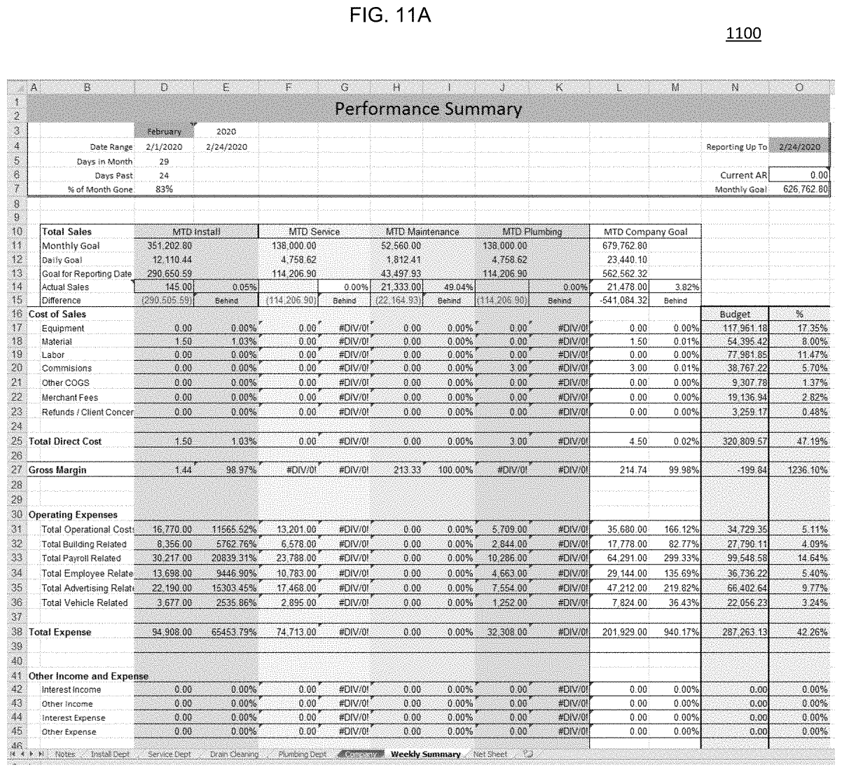

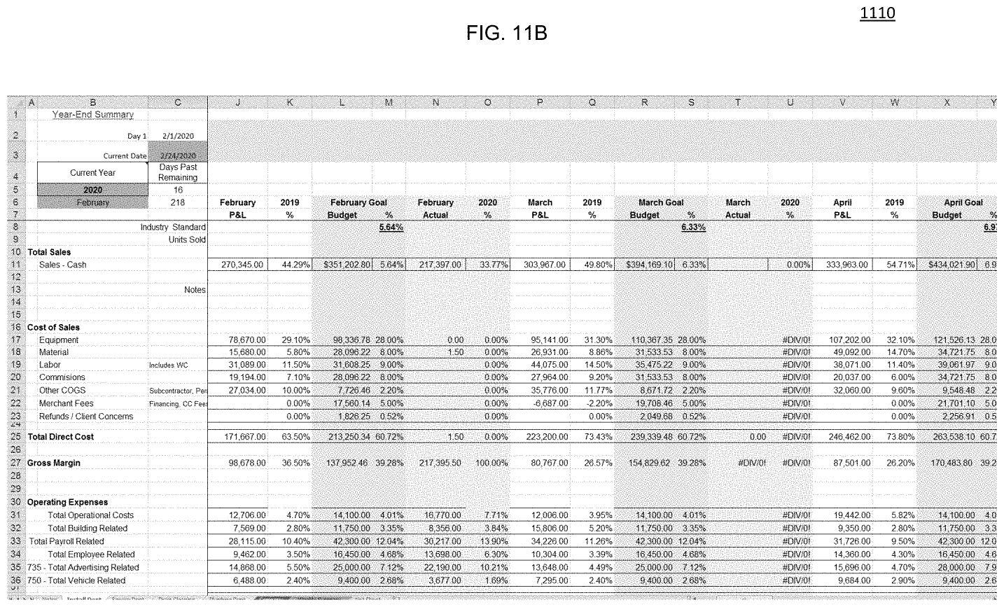

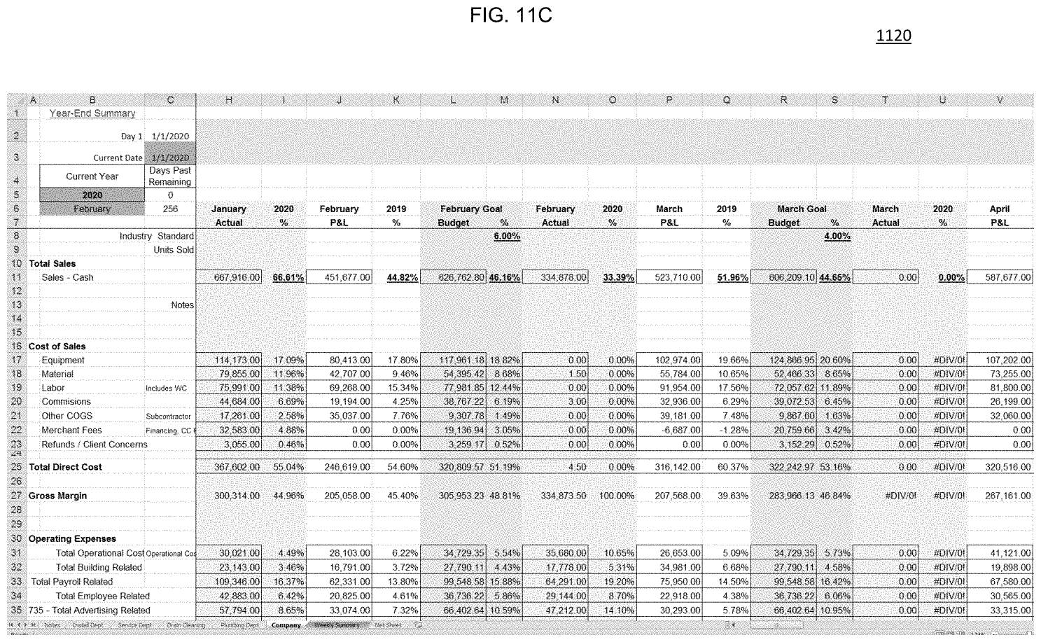

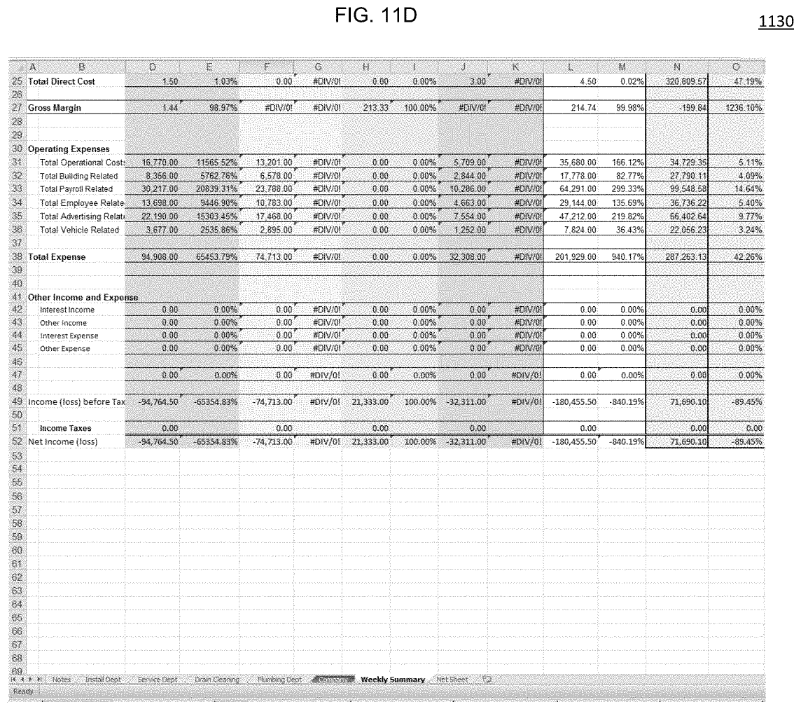

At step 518, the system may be configured to generate user interfaces for Obtaining Performance Triggers. Exemplary user interfaces generated at step 518 are depicted in FIGS. 5J and 5K. In FIG. 5J, the user interface 550 depicts a performance summary that includes sales goals, actual sales data, and appointment data from accounting and scheduling software. This data may be used to determine whether any performance trigger conditions have been met based upon underperformance, which could trigger different types of back up campaigns to be implemented to increase sales and make up underperforming campaigns. If a business is weather driven, weather forecasting is calculated. FIG. 5K depicts different campaigns 552, 554 that could be triggered, and the conditions (e.g., 10% below target) that trigger the campaigns. In addition, FIG. 5K depicts that different triggers may be implemented for different departments of a company, showing that the HVAC Installations department and the HVAC Services departments have different trigger conditions and campaigns that are triggered. FIGS. 11A-11D also depict a Performance Summary and related sub-tables/sub-spreadsheets 1100, 1110, 1120, and 1130 developed in relation to the Performance Summary, including separate year to date spreadsheets for different departments—Install, Service, Drain Cleaning, Plumbing—of the entity company. The Summary is based upon data input by the user, data imported from the user's accounting, sales, and marketing systems, and formulas in the spreadsheet to determine yearly and monthly budgets and other parameters such as sales and profits as they compare to goal sales and profits.

At step 520, the hub computer system is configured to automatically generate a calendar (FIG. 5L) that provides a schedule of the different ad campaigns planned and the costs associated with the campaigns, on, in this exemplary calendar, a monthly basis. In this particular example, monthly and weekly budgets are shown, as well as weekly spends. The calendar provides the basis for the launch of the marketing campaigns by hiring marketing companies and freelancers to implement the various ad campaigns.

In embodiments, the calendar 556 of FIG. 5L, or any table or spreadsheet generated by the hub computer platform, such as the spreadsheet 414 of FIG. 4B, may also include be configured to depict profit and loss data. The profit and loss data may be obtained by the hub computer platform through the generation of additional interfaces in Step 510 for obtaining profit and loss data for the entity seeking marketing services. Alternatively, the profit and loss data may be obtained automatically by the hub computer platform from the entities' accounting systems through the use of an API. The hub computer platform may be configured to include on the calendar, or other spreadsheet, based upon the profit and loss data, a net profit column per week or month. The net profit data will typically differ from a table reflecting sales data because sales data reflects expected revenue but the profit data is based upon actual payables received, which are typically received after the making of a sale (i.e., not in real time at the time of sale).

As discussed in relation to FIG. 5B, the hub computer platform may be configured to generate a spreadsheet with a campaign depicting how sales requirements are met with ad types. In an embodiment in which the hub computer platform is also configured to receive profit and loss data, campaigns may also be developed based upon desired profit, instead of, or in accord with, sales requirements. Thus, in an embodiment, the spreadsheets 414 and 416 of FIGS. 4B and 4C may be generated so that the type and amount of marketing performed each month or week is based upon desired profit goals, rather than sales goals, per month or per week. In this embodiment, the hub computer platform may be configured to generate the spreadsheet with a profit goal for each month based upon total profit for the year. Each months profit goal may be adjustable by the user. Triggers for different ad campaigns may also be based upon profits rather than sales.

In another embodiment, a combination of sales goals and profit goals may be used to generate the types and amount of marketing performed for the entity for the spreadsheet. In this embodiment, initial graphical interfaces of step 502 in FIG. 5A may be configured to obtain profit goal and sales goal information from the entity. The hub computer platform may be configured to generate the spreadsheet with both a profit goal and a sales goal for each month, with each goal being adjustable each month. Thus, a certain entity may be involved in an industry in which certain months are slower than other months, and profit and sales goals in those months may be adjusted accordingly. Similarly, the entity may seek to increase sales goals in the months preceding the slow period, with the goal of receiving the profit for those sales during the slow months. Different combinations of profit and sales goals may be selected by the user to account for different factors in their particular industry such as high and low sales periods and typical turnaround times for payment of invoices in the industry. The hub system may implement particular types of campaigns based upon desired increased profit for a particular month, and may implement ads that typically result in quicker sales (e.g., online ads versus local clipper or neighborhood ads, provided that historical data does not indicate that the ads are already saturated in a particular type of campaign. For spreadsheets in which profit goals and sales goals are used to identify marketing buys, triggers for different campaigns may be based upon profit goals, sales goals, or a combination of both. In other embodiments, the hub computer platform may provide a company seeking marketing services with a number of different parameters upon which triggers may be set, including but not limited to profit goals and sales goals.

Steps 524-532 generally correspond to the launching step 440 of FIG. 4, in which the hub computer system facilitates the assignment of marketing tasks by the company seeking marketing services and the performance of the marketing tasks by marketing companies and freelancers.

At step 524, the system may generate a flow chart 438 of all activities for the launch, as shown in FIG. 4N. The system is configured to provide each responsible party with interfaces for assigning tasks from a project to marketing companies or freelance individuals or entities.

At step 526, the system may generate an interface with different campaigns from which the responsible party may select, such as the interface 440 shown in FIG. 4O. Then, in step 528, the hub system may generate an interface 442 that depicts the individual tasks that need to be performed for the selected campaign. FIG. 4P. At step 530, for each individual task, interfaces 558 may be generated depicting available marketing companies (FIG. 5M) or freelancers 444 (FIG. 4Q) available to perform the task, and interfaces 446 that describe the task details (FIG. 4R). In an embodiment, the interfaces for selecting marketing companies or freelancers to perform tasks may include filters that allow marketing companies and freelancers to be shown according to different factors. For example, the filters may be selected to show companies or freelancers that have flat rate marketing management, that have project based marketing fees, that have performance percentage on spend, based upon cost per lead, and based upon cost per sale. Additional filters may be based upon price, reliability, delivery time, ROI (return on investment), cost per sale, and key performance numbers. The interface also has the ability to award work globally so that a single marketing company receives all of the work, or in a piece-meal manner so that different campaigns and/or different tasks are awarded to different marketing companies.

As will be understood, the data in FIG. 5M may typically be provided by the companies offering marketing service themselves, who may use the hub as an outlet to offer their services to potential client companies seeking marketing services. The hub computer system is configured to provide interfaces to marketing companies (i.e., companies offering marketing services) as well as to companies seeking marketing services. The interfaces provided to the marketing companies may include queries concerning each marketing company's policies and performance, such as whether the company has a flat rate marketing management, whether the company offers project-based marketing fees, the company's performance percentage on spend, at what each company's cost per lead and cost per sale performance has been. Typically, marketing companies will welcome providing such information to the hub computer system, because provision of the information enables the marketing companies to participate in the hub so they can be considered for marketing campaigns. Similarly, the hub computer system may provide interfaces to freelancers to obtain information concerning their policies and performance.

In embodiments, the hub computer system provides a production center, which includes user interfaces of the listings and reviews for marketing companies and freelancers, as well as user interfaces for providing a task-based approach to the fulfillment of marketing campaigns. The Production Center is where companies go to review and hire marketing companies, and where freelancers can be hired for tasks.

The Production Center of the hub computer system is where marketing companies go to get their work done, with consistency of both work and procedure/protocol, and not limited to a location from which to engage freelancers. Local companies would go to the Marketplace to review and hire Marketing Companies to do the marketing. The production center is designed for the marketing companies' production of pre-specified individual detailed process and procedure for each task and freelancer skills to implement. Keeping business process & procedures consistent from individual small project up to and including a full list of tasks to complete a project. The self-contained control board is the hub for all activity.

The features of the hub production center includes:
1. Lists of marketing projects by category
2. Lists of marketing projects by sub category
3. List of price range by approved freelancer
4. Lists of relevant projects skills with tasks and full blueprint
5. Each task and blue print has predetermined process for project
6. Each process has predetermined procedure to follow for each task of the Blue Print
7. Each process has predetermined procedure to follow for each task with timing, occurrence and more
8. List of freelancers with time to start and complete, price and rating
9. Pre-determined process for each step with instructions in content, charts or video's.
10. Platform collaboration constantly improving products, instructions and blue prints. Think of a Wiki for marketing procedures and blue prints
11. Communications control board for all communications
12. Control Board lists categories of set up tasks to do and implementation
13. Control Board lists Project, To do, Needs review, Done
14. Control Board provides above work flow in real time. Acceptance, Start, percentage of completion, expected end time, reviews, approval
15. All communications are on control board text, and video
16. Freelancers are given user names and never identified
17. The marketing company can have multiple users
18. The marketing company can have multiple projects
19. Payments are made through the control board platform
20. Marketing company shares and blueprints and gets royalties
21. The freelancer's reviews have filter by location, language, reviews, price, value of work completed, Individual or part of a larger firm, availability, education, and samples.

The production center provides for advantages to freelancers, allowing them to review information before accepting an assignment. Prior to freelancer acceptance, the freelancer can review the company:
Company reviews
Success rating
Payment volume
Completion success
Type of company
Age of business
Amount of work they will provide
Type of work they do
Fluency of Language
Location of business

Each of the above features and capabilities may be implemented within the computerized system and platform described herein to provide and generate displays, images, interactive features, analyses, and program results for each of the above enumerated items. By way of example, such items include a single display listing of marketing projects by category, with market companies identified alongside relevant categorical markings and company designation information; SEO display page and results, including selection criteria; Lists of relevant projects skills with tasks and or full blueprint, each task and blue print having a predetermined process for project.

In an exemplary embodiment, large and small blue print displays may be created, with large blue prints having many tasks and each task having multiple instructions configured in a work flow model (in contrast to, e.g. other models such as a mind map). Each process has predetermined procedure to follow for each task of the Blue Print. Moreover, each process has a predetermined procedure to follow for each task with timing requirements, occurrence requirements, and the like.

Further the system, operates to display a list of freelancers with time to start and complete, price and ratings information displayed/displayable on the screen, and pre-determined processes for each step with instructions in content, charts or videos. Further still, platform collaboration is enabled for constantly improving products, instructions and blue prints, with the system providing a display area for adding marketing procedures and blue prints as headings. A Communications control board for all communications enables the image to now be tied into the heading. In an embodiment, the Control Board lists categories of set up tasks to be performed and implementation. In an embodiment, the Control Board lists Projects, To do Actions, Needs Review Alerts, and Done Status to facilitate interactive operation. The Control Board provides the above work flow in real time, including but not limited to Acceptance, Start, Percentage of Completion, Expected End Time, Reviews, and Approval. In an embodiment, all communications are on control board text, and video. In operation, Freelancers are provided user names and anonymized such that actual names/addresses are not identified. In an embodiment, the marketing company can have multiple users. In an embodiment, the marketing company can have multiple projects. In an embodiment, payments are made through the control board platform with prepaid credits or dollars. Credits may be used due to international business considerations. In an embodiment, the system enables a marketing company which shares process and procedures for tasks and blueprints to calculate and obtain royalties with each sale of use. Three tier royalty may be implemented based on the volume sold and inventory of blue prints. The system enables the freelancer's reviews for filtering by location, language, reviews, price, value of work completed, by individual or part of a larger firm, availability, education, and samples.

The task-based approach of the hub computer system differs significantly from existing processes used to perform marketing campaigns. For example, one existing system uses custom details of an assignment to identify freelancers. Another system identifies freelancers based upon their skill. Yet another system selects freelancers based upon the work description of a project. These approaches are inefficient for selecting freelancers and marketing companies, and involve time consuming interview processes. The approaches often lead to hiring based upon style, with frequent employment turnover and inconsistent work among multiple freelancers. In addition, these approaches do not scale with consistency.

In contrast, the task-based approach implemented by the hub computer platform is configured for the marketing companies' production of pre-specified individual detailed process and procedure for each task and freelancer skills to implement. The approach provides for keeping business process and procedures consistent from individual small projects up to and including a full list of tasks to complete a project. A self-contained control board generated by the hub provides the center for all market launch activity. The hub computer platform includes functionality to generate lists of marketing projects by category, lists of marketing projects by sub category, a list of price range by approved freelancer, and lists of relevant projects skills with tasks and full blueprint. In addition, the hub computer platform is configured to associate a blue print and procedure for each task—each task and blue print has a predetermined process for a project, each process has a predetermined procedure to follow for each task of the Blue Print, and each process has a predetermined procedure to follow for each task with timing, occurrence, and more.

The hub computer platform is configured to provide the production center with numerous other features and functionality. In embodiments the hub computer platform is configured to provide additional functionality features including:
Generating a list of freelancers with time to start and complete, price and rating;
Generating pre-determined processes for each step with instructions in content, charts or videos;
Collaboration functionality for improving products, instructions, and blue prints;
A communications Control Board for all communications between responsible parties of the company, marketing companies, business consultants, freelancers, and other involved parties, including audio, video, and text;
A Control Board that lists categories of set up tasks to do and implementation;
A Control Board that lists Project, To do, Needs review, and Done;
A Control Board that provides above work flow in real time. Acceptance, Start, percentage of completion, expected end time, reviews, approval;
Naming functionality for providing Freelancers user names so they are not identified;
Assignment of users for the marketing company to access the hub computer platform, including multiple users;
Generating multiple projects for each marketing company;
Payment functionality through the Control Board platform for payment of marketing companies, freelancers, and business consultants, with prepaid credits or currency;
Functionality to set up royalties for the sharing of marketing plans, process and procedures for tasks, and blueprints; and
Functionality for filtering freelancer reviews by location, language, reviews, price, value of work completed, Individual or part of a larger firm, availability, education, and samples.
Functionality for freelancers to review the company seeking marketing services or a marketing company seeking details, before accepting a project or task, based upon information such as Company Reviews, Success rating, Payment volume, Completion success, Type of company, Age of business, Amount of work they will provide, Type of work they do, Fluency of Language and Location of business.
   The foregoing functionality is typically generated by the hub computing platform and made available to users via graphical user interfaces, to facilitate the coordinated planning and launching of marketing or business campaigns by the company seeking marketing services, the company providing marketing services, freelancers, and business consultants.

At step 532, the system is also configured to provide interfaces 448 for communicating with a selected marketing company or freelancer. FIG. 4S. In embodiments, the communication may be anonymous, such that one or both of the identity of the company or the responsible party for the particular task is not revealed to the marketing company or freelancer. The hub may be configured to generate interfaces for both the company and the marketing company or freelancer. The interfaces may include, in addition to communications interfaces, interfaces for identifying the tasks, and details for the tasks, to the marketing company or freelancer. These tasks and details were previously generated using the interfaces during the planning phase. In embodiments, the details may include an overview 450 of all of the tasks, as well as step-by-step details of the tasks for the marketing company or freelancer to perform. FIG. 4T.

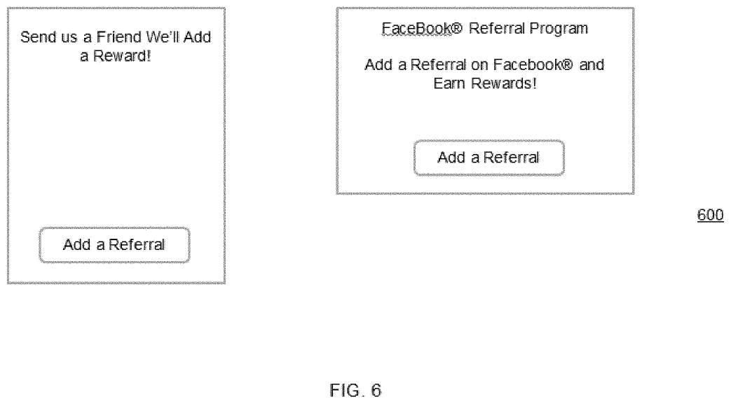

FIG. 6 depicts details regarding interfaces for an organized referral system 600. Often, companies ignore the importance of referrals in generating business. In fact, word of mouth/social/referrals are KING when it comes to marketing a business.

The hub computer system may be configured to implement a formal referral system. In embodiments, in addition to facilitating planning and implementation of marketing programs by companies seeking marketing services and marketing companies/freelancers, the hub computer system may be configured to track referrals by customers. The hub computer may be configured to automatically generate emails, for customers who have completed business with the company and have indicated satisfaction with the products and/or services they received, which include a referral to a distribution list that the customer may edit. Shareable referrals for Facebook® and Twitter® may also be generated. Business generated as a result of the referral may be tracked by the referral tracking system, such as by a marketing pixel or by an ID # at the choice of the customer.

Customers may be incentivized to participate in the referral system by the implementation of a rewards system tracked by the hub computer system. For example, an HVAC company can provide a reward of a free heater tune up for every two customers referred to the HVAC company by a customer. Other rewards can be tied to local business partnerships, such as providing the customer with a gift certificate for a movie and dinner package for two, for a set level of referrals. Because the system has data relating to the cost of obtaining business, the value of the rewards can be based on that data. The rewards can scale as needed.

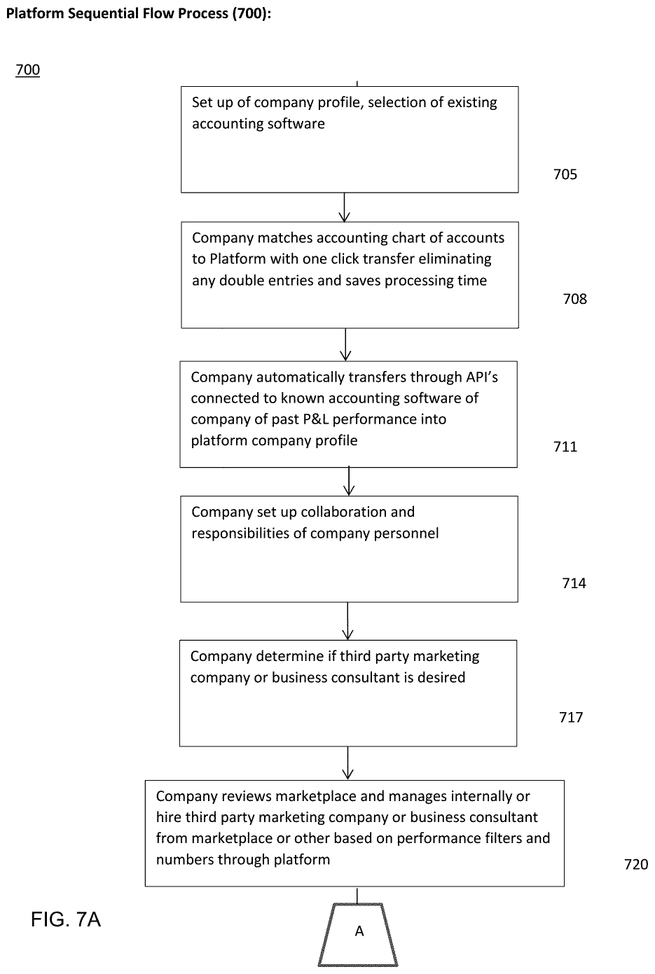

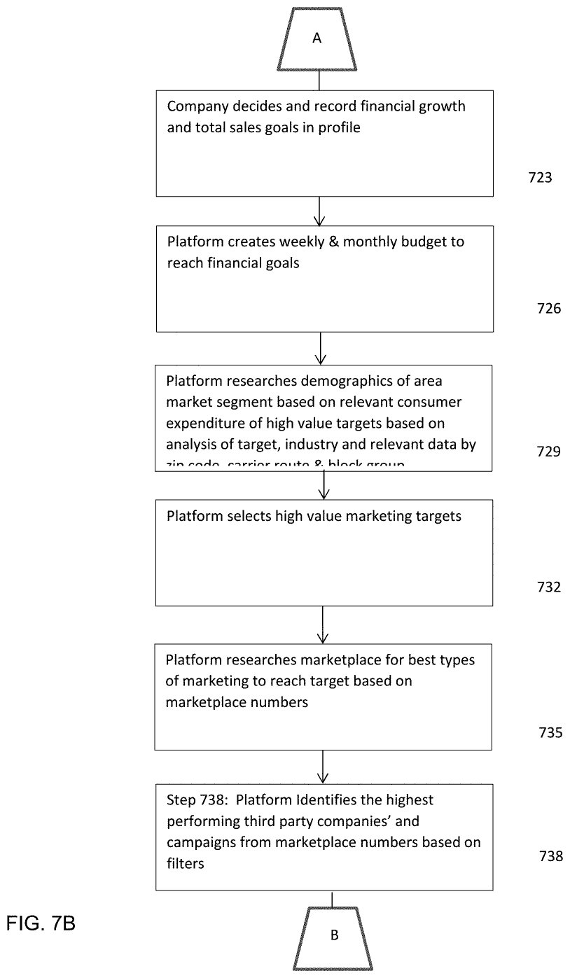

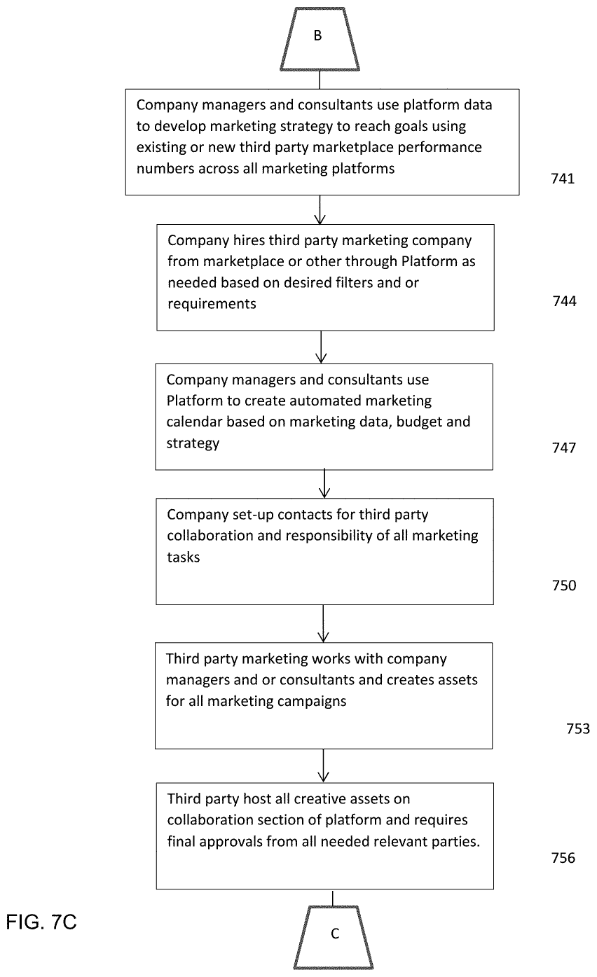

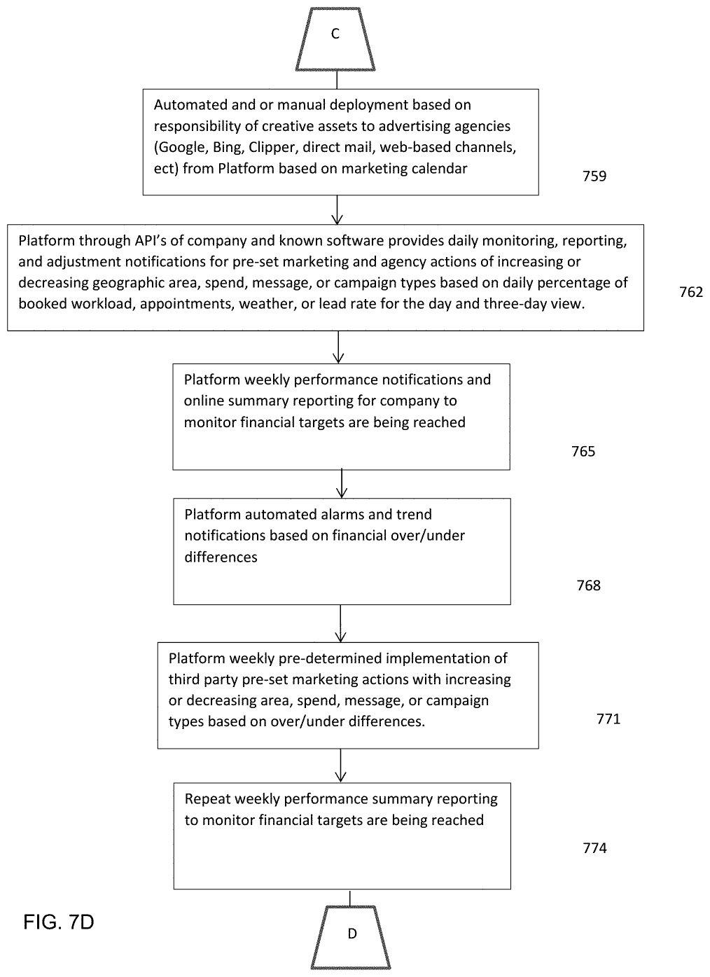

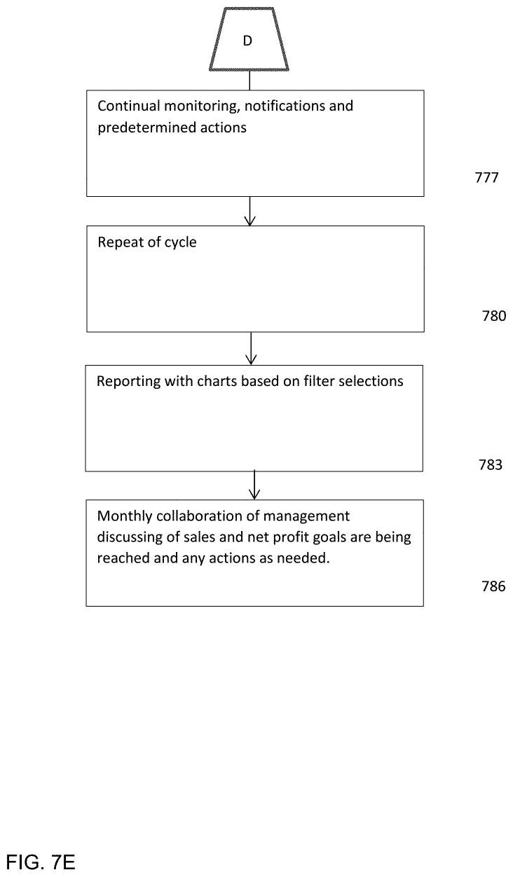

FIGS. 7A-7E depicts an alternative sequential flow process 700 for facilitating the generation of marketing or business for an entity seeking marketing/business services by one or more entities that provides marketing or business services. In the initial steps of process 700, the hub computer platform is configured to generate interfaces to obtain information from the entity seeking marketing/business services (the “entity”). At Step 705, the hub computer platform is configured to generate interfaces for the entity seeking marketing/business services to set up a company profile, and to select and identify its existing accounting software so that an API could be selected to provide certain of the accounting data to the hub computer platform. At Step 708, the hub computer platform generates an interface that presents accounting charts to the entity seeking marketing/business services. A user at the entity may use the interface to match an accounting chart of accounts to the hub computer platform with a one click transfer, eliminating any double entries and saving processing time. At Step 711, the hub computer platform is configured to receive data from the entity's accounting software; the entity's system may automatically transfer deployment accounting data through API's connected to the entity's identified accounting software, including past profit and loss data (P&L)

After the basic data from the entity is received, the process comprises steps for generate user interfaces for planning the marketing/business services to be purchased or arranged. At Step 714, the hub computer platform may be configured to generate interfaces for the entity to set up collaboration and responsibilities of entity/company personnel. At Step 717, the hub computer platform may be configured to generate interfaces to determine whether the entity is seeking a marketing company or a business consultant. Responsive to whether the entity is seeking marketing or business services, at Step 720 the hub computer platform is configured to generate an interface that presents a marketplace of different providers of the marketing or business services. The interface includes performance filters for filtering candidates, as well as reviews and scores for different providers. At Step 723, the entity may select one of the marketing or business companies for engagement from the interface. In response, the hub computer platform may then generate interfaces for obtaining financial growth and total sales goals for the entity seeking services.

Based upon the information provided by the entity, at Step 726 the hub computer platform generates a weekly & monthly budget to reach financial goals. The budget may be provided to the entity in an interface including a table or spreadsheet.

The hub computer platform may then be configured to perform a number of steps to determine the types of advertising to be used for the entity. At Step 729, the hub computer platform may be configured to research demographics of area market segment based on relevant consumer expenditure of high value targets based on analysis of target, industry and relevant data by zip code, carrier route & block group. At Step 732, the hub computer platform is configured to select, based upon its research, high value marketing targets. At Step 735, the hub computer platform is configured to research the marketplace for best types of marketing to reach target based on marketplace numbers. At Step 738, the hub computer platform may be configured to identify the highest performing third party companies' and campaigns from the marketplace numbers, based on filters applied to the interface that shows the companies in the marketplace.

At Step 741, entity/company managers and consultants may access data on the hub computer platform, to develop a marketing strategy to reach goals using existing or new third party marketplace performance numbers across all marketing platforms. At Step 744, the entity/company may access the interface that depicts the marketplace of available marketing or business companies, to select for hire a third party marketing company as needed based on desired filters and or requirements, if a marketing company was not previously selected.

At Step 747, the hub computer platform may be configured to generate, or allow company managers and consultants to generate, an automated marketing calendar based on marketing data, budget, and strategy. The hub computer platform may be configured to generate a graphic interface depicting the calendar. At Step 750, the hub computer platform is configured to generate interfaces to allow the entity to set-up contacts for third party collaboration and responsibility of all marketing tasks. At Step 753, the Third party marketing works with company managers and or consultants and creates assets for all marketing campaigns. The hub computer platform is configured to provide for collaboration between the stakeholders and relevant parties for each asset and marketing campaign. In an embodiment of Step 756, the third party marketing entity hosts all creative assets on a collaboration section of the hub computer platform, and the hub computer platform is configured to require final approvals from all needed relevant parties.

At Step 759, the hub computer platform is configured for automated and/or manual deployment of the developed creative assets based on responsibility to advertising agencies (Google, Bing, Clipper, direct mail, web-based channels, etc.) based on the marketing calendar.

After the marketing campaigns and creative assets are deployed, sales and profits and other accounting and marketing metrics may be monitored. Thus at Step 762, the hub computer platform through API's of the company and known accounting or marketing software receives daily monitoring, reporting, and adjustment notifications for pre-set marketing and agency actions of increasing or decreasing geographic area, spend, message, or campaign types based on daily percentage of booked workload, appointments, weather, or lead rate for the day and three-day view. At Step 765, the hub computer platform may generate interfaces to enable a user to generate weekly performance notifications and online summary reporting for the company to monitor financial targets, to determine if they are being reached. At Step 768, the hub computer platform may be configured to generate interfaces to set automated alarms and trend notifications based on financial over/under differences between sales or profit goals and performance numbers.

In embodiments, the hub computer platform may also be configured to continually monitor the differences between sales or profit goals and performance numbers, and to implement pre-set marketing actions based upon the performance. For example, at Step 771, the hub computer platform may be configured to make a weekly determination as to whether to implement pre-set marketing actions with increasing or decreasing area, spend, message, or campaign types based on over/under differences. The determinations may be made based upon set trigger points. In embodiments, the hub computer platform is configured to repeat the reporting and monitoring steps. At Step 774, the hub computer platform may be configured to repeat the weekly performance summary reporting to monitor whether financial targets are being reached. At Step 777, the hub computer platform may be configured to repeat step 771 to monitor, send notifications, and determine whether predetermined actions should be implemented. At Step 780, the hub computer platform is configured to repeat the monitoring, notification, and implementation of predetermined actions.

At Step 783 of the flowchart 700, the hub computer platform may be configured to generate interfaces with reports that includes charts and information presented based upon filter selections. At Step 786, the hub computer platform may be configured to schedule and/or facilitate a monthly collaboration of management for the discussion of sales and net profit goals, and the consideration of whether additional marketing actions are needed to achieve sales and profit goals.

In embodiments, there may be conditions on use of the hub computer platform. For example, one condition could require that all communications for requests for services or provision of services are made through the platform, rather than through outside channels such as email. Such a condition will provide for a centralized location for all communications, rather than requiring entities to search their personal accounts for communications. Another condition may require that all hiring of marketing companies and freelancers be performed through the platform. This condition may again provide for improved communication and processing of marketing needs, as it centralizes all tasks and coordination of tasks. In addition, requiring hiring to be performed through the hub may increase the quality of services available, as the marketing companies, consultants, and freelancers are aware that their performance is rated on the hub. Ideally, all processes, communications, and interactions, are performed through the hub computer platform.

Centralization may also facilitate monetization of the hub computer platform. As will be understood, the creation of the hub computer platform will involve significant expenses for both hardware to house the hub computer platform and software to implement the processes and interactions of the hub computer platform. In embodiments, an entity responsible for creating and maintaining the hub computer platform may charge a fee for use of the platform by entities seeking marketing services and/or the entities providing marketing services. Any type of fee arrangement may be implemented, including but not limited to a flat fee, a percentage fee, a fee on sales generated, or a fee based upon revenue generated through placement of ads such as through the Google® Adsense program and similar programs. In embodiments, the hub computer platform may be configured to facilitate payments to marketing service providers, business consultants, and freelancers by the company seeking marketing or business services. Fees owed the hub computer platform can be assessed from the fee paid by the company seeking marketing or business services, or fees may be assessed at any other time during the marketing or business campaign development and implementation process.

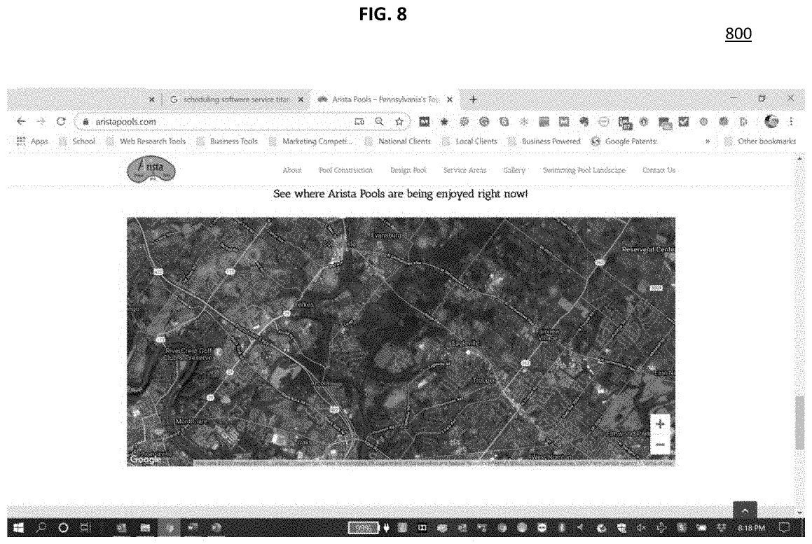

FIG. 8 depicts a heat map 800 that may be generated by the hub computer platform, which may depict customers that have used services provided by an entity that has used the hub. For example, a swimming pool company may seek marketing services using the hub. After the marketing services are provided, the hub system may be configured to receive data identifying the sales made as a result of the marketing services, which may include address data for customers. From this address data, a heat map of customers may be generated by the hub computer system.

As additional companies use the hub computer platform for marketing services, the number of customers in the database will increase. The representation of the customers on a heat map provides a strong visual cue to companies considering using the hub computer platform for marketing on the reach and success of the hub computer platform. In this way, existing customers may be leveraged to encourage new customers to use the hub computer platform for marketing. The heat map may be especially useful in relation to the encouragement of companies that provide services to particular locales.

In an embodiment, the hub computer system may also include an inspection station. The Inspection station may be configured to store, generate, and apply checklists to review existing marketing, in a manner similar to how a checklist may be used in the HVAC industry to review HVAC systems. An inspection manual or automation may check each type of system, platform, or product. The assessment based upon the check list may result in a pass, an attention needed, or a fail status. Each line item on the checklist has an associated formula defining a task that can be performed by a marketing company or a freelancer in the marketplace to correct or improve the item. The bottom of each checklist may have a “Summary of work needing to be done” that is based upon the assessment made using the checklist, which may include a cost for a repair of an attention needed or fail status item on the checklist, and a recommended marketing service provider for the repair. The relevant formula (which may be defined in the performance summary spreadsheet or other spreadsheet that summarizes budget information, performance goals, and real-time performance) identifies the tasks needed to be performed to address the attention needed or fail status. The marketing services purchaser has the option to perform the tasks itself, or to have the tasks generated for assignment to a marketing services provider. In an embodiment, the inspection station of the hub computer platform may identify a recommended marketing company or freelancer for each task. After the tasks have been performed, the inspection station checklist may be reassessed to determine a status for the task. In embodiments, the inspection station could generate an order to complete the item that has failed or needs work, which may include a delivery date by which the work must be performed. In embodiments, the inspection station may be a separate module or a part of the hub computer platform.

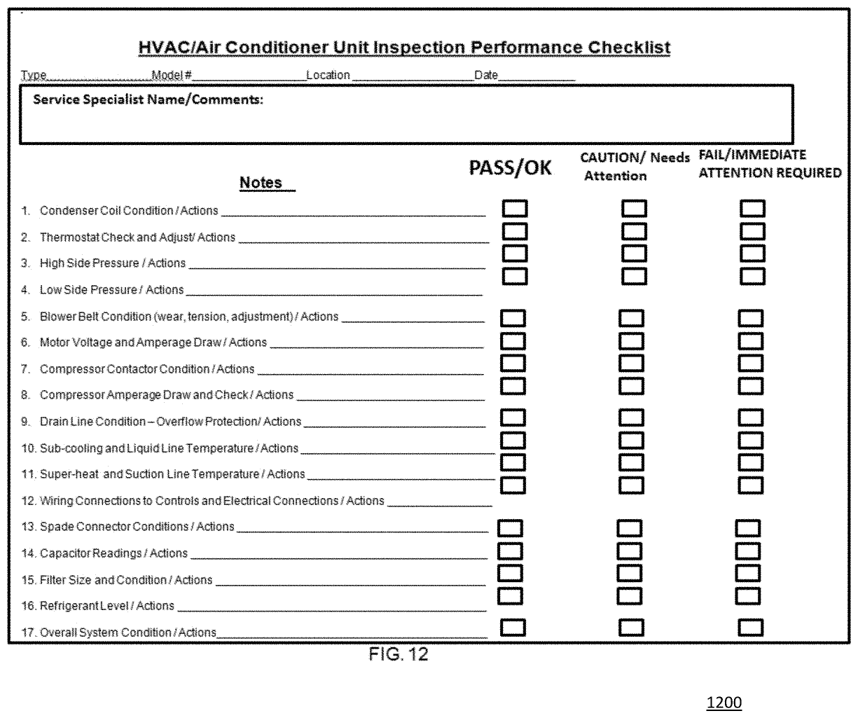

FIG. 12 depicts an exemplary HVAC inspection checklist 1200 with status colors corresponding to the status of individual systems or functions which have been inspected. As shown in FIG. 12, the HVAC inspection checklist includes individual items that can be inspected on an HVAC. Color coding (e.g., red, yellow, green) used to depict the result of the inspection, making it easy to identify the items that have failed inspection. The checklist results by the inspection station may also implement color coding to provide for quick identification by a company of shortcomings in their marketing.

As noted, the inspection station includes checklists for reviewing the state of existing platforms, products, or marketing channels by the company that is seeking marketing services. The review of the state of existing marketing channels may be used to determine the additional marketing tasks that are required to achieve the sales goals of the company seeking marketing services, such as in relation to step 406 of FIG. 4 or steps 514-528 of FIG. 5B The cost of the additional marketing tasks and the budget set by the company may also be used to determine the additional marketing tasks required.

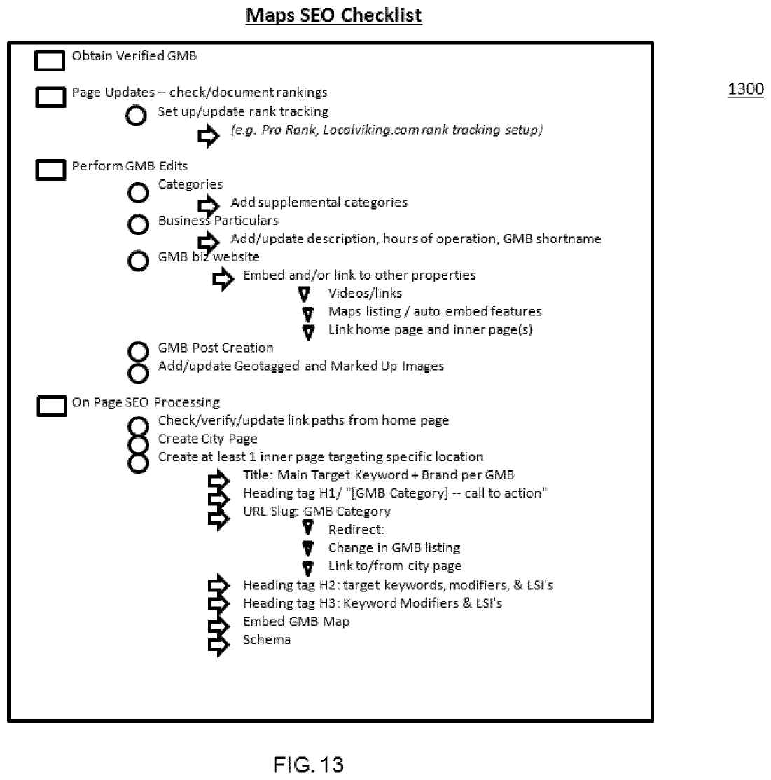

For example, the inspection station may include a checklist 1300 for reviewing the current state of information provided on the Google® maps interface, as shown in FIG. 13. The hub computer system would be configured to review the information for the company on the Google® maps interface and compare it to a checklist in the inspection station to assess the Google® maps interface to determine whether appropriate information is provided by the interface. For example, the checklist may include checklist items for checking whether the company name is proper, whether the company's phone number is included on the page, whether the company's hours are included on the page, and whether an accurate description of the company's business is included. After reviewing the maps interface, the hub computer system is configured to identify the items in the checklist that fail or need attention. In an embodiment, the items that fail or need attention may be included in the tasks to be performed by the company providing marketing services or one or more freelance marketing services providers.

Thus, the hub computer platform is configured to access at least one third party computer system comprising a marketing channel on which the marketing services purchaser has existing advertising. The hub computer platform is then configured to compare, based upon the access of the at least one third party computer system, the existing advertising on the marketing channel to a checklist of desired marketing on the marketing channel, comprising a checklist in the inspection station. After accessing the marketing channel and comparing the checklist to the marketing on the channel, the hub computer system is configured to identify the items in the checklist that need attention. The items in the checklist that need attention are tasks that need to be performed. When the hub computer platform generates interfaces including the tasks for assignment to the one or more marketing service providers, the tasks are based upon the results of the checklist, namely the tasks that were identified as needing attention. This entire process may be automated and computerized by the hub computer platform, and/or the inspection station module of the hub computer platform, so that a company needing marketing services need not perform this checklist assessment themselves.

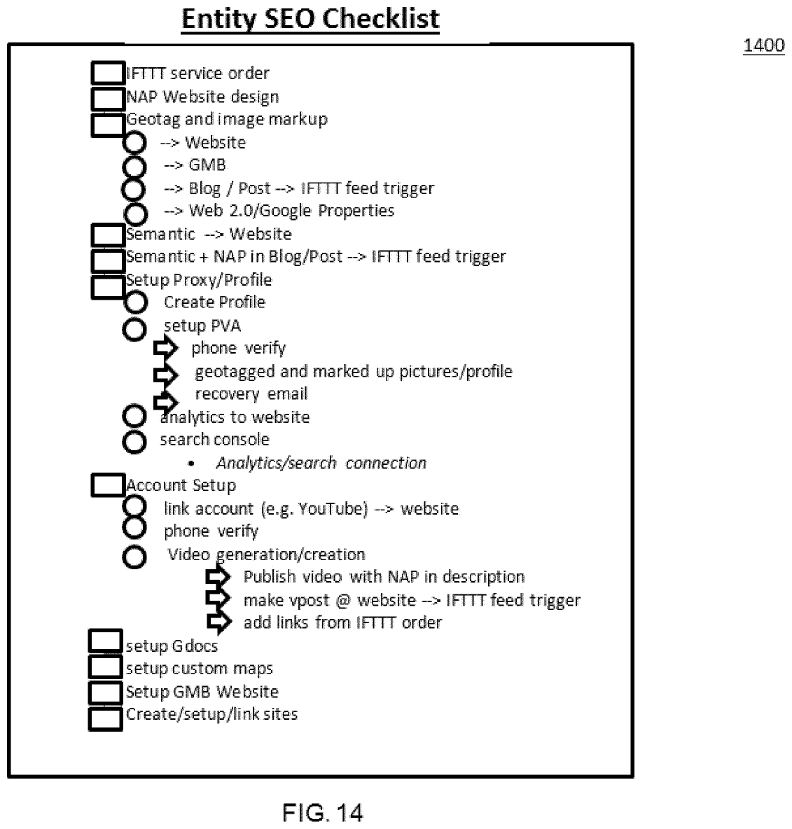

FIG. 14 depicts an Entity SEO Checklist 1400 that may be applied by the Inspection Station to review the current state of information provided on the search engine optimization for the entity. The hub computer system would be configured to review the information for the company's search engine optimization efforts, including individual SEO tasks that would be included in a comprehensive SEO program.

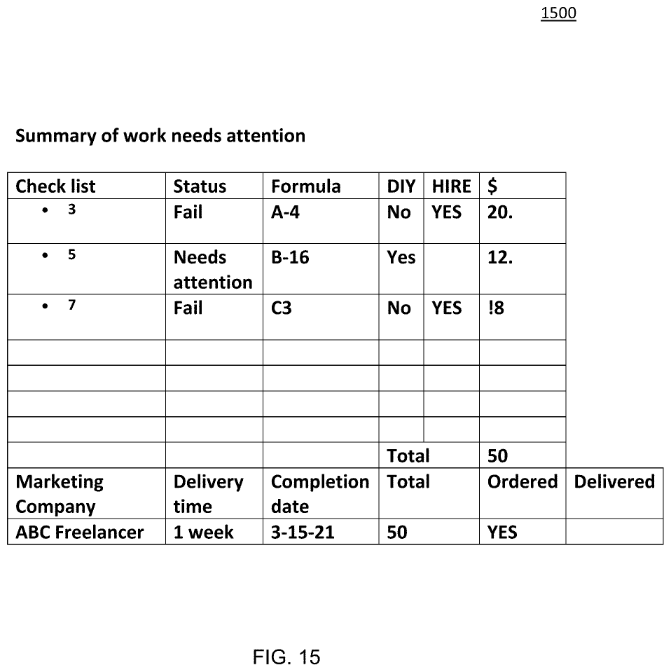

FIG. 15 depicts an Output Table 1500 that may be generated by the Inspection station based upon application of the Google maps checklist to the individual tasks or marketing channels on the checklist. As depicted in FIG. 15, the Output Table may include the checklist items that either failed or need attention. The table also includes a formula number for each checklist item, that corresponds to a formula for the checklist item in the performance summary checklist. The table may also include a field indicating whether addressing the checklist item is something that can be done by the company, such that it does not require a marketing company or freelancer to do the necessary work. In addition, the table might include a field to indicate if a marketing company or freelancer was hired, as well as a field to indicate the cost of each checklist item that needs attention or which failed the inspection. Finally, the table may include fields to indicate the name of the marketing company or freelancer hired for each task, the delivery time for completion of the task, the completion date for the task, the total cost for completion of all of the tasks, whether the work has been ordered for each task, and whether the tasks have been completed and delivered.

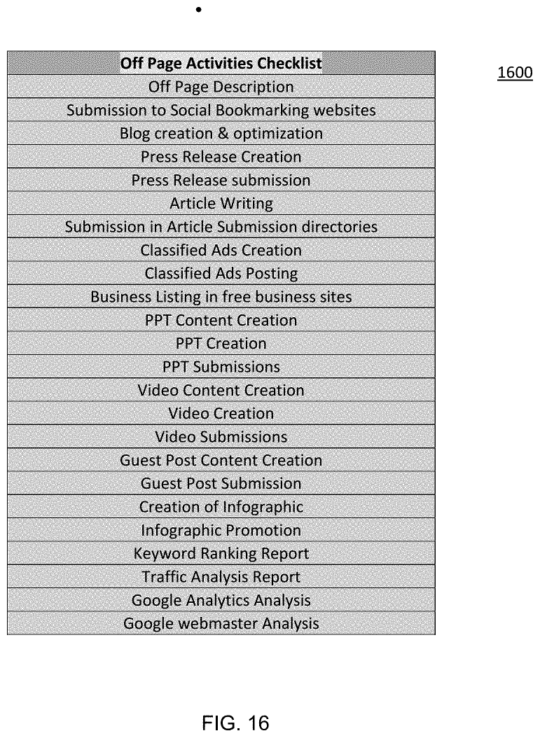

FIG. 16 depicts an Off-Page Activities checklist 1600 of marketing tasks. This checklist may be used to identify off-page activities (i.e., activities that are separate from the company's own web site) that may be performed to increase marketing awareness of the company. The representative list is not exhaustive, and those of ordinary skill in marketing will understand that additional tasks may be identified. FIG. 16 includes tasks such as Off Page Description, Submission to Social Bookmarking websites, Blog creation & optimization, Press Release Creation, Press Release submission, Article Writing, Submission in Article Submission directories, and so on. In an embodiment, the hub computer platform and/or inspection station are configured to access third party computer systems to identify the existing state of off-page marketing activities. Thus, for example, as part of the inspection station, or otherwise as part of the hub computer platform, the system is configured to identify articles and press releases concerning the company that are available through the Internet. Based upon the findings, the system may be configured to determine a status for each of the steps, such as whether the “Press Release Submission” element on the checklist has a status of failed, need attention, or pass. For elements that are need attention or failed, the hub computer system is then configured to generate a list of tasks that should be performed to bring the element to a pass status.

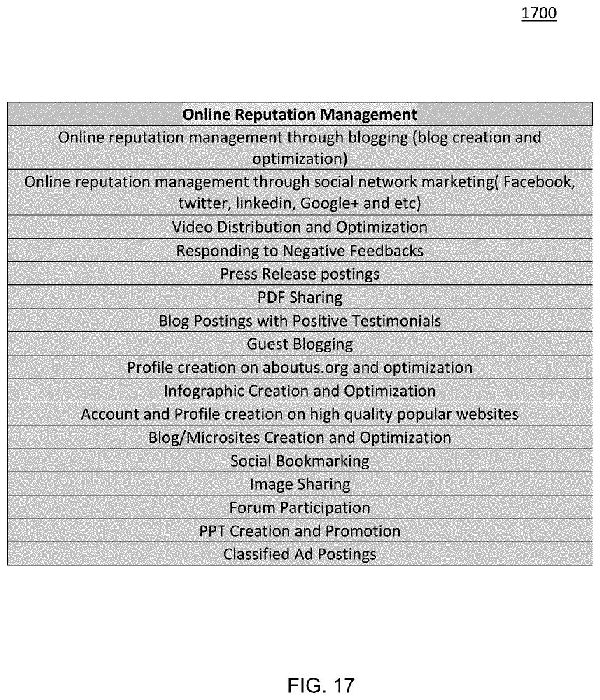

FIG. 17 depicts Online Reputation Management checklist 1700 marketing tasks. The representative list is not exhaustive, and those of ordinary skill in marketing will understand that additional tasks may be identified. FIG. 17 includes tasks such as Online reputation management through blogging (blog creation and optimization), Online reputation management through social network marketing (Facebook®, Twitter®, LinkedIn®, Google+®, and etc.), Video Distribution and Optimization, Responding to Negative Feedbacks, and so on.

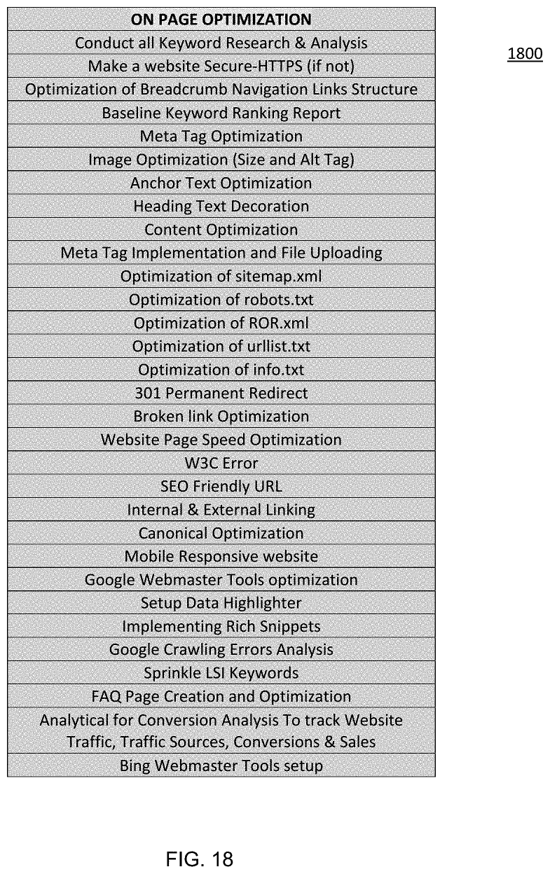

FIG. 18 depicts On-Page Optimization list 1800 marketing tasks, corresponding to elements of the company's own web page. The representative list is not exhaustive, and those of ordinary skill in marketing will understand that additional tasks may be identified. FIG. 18 includes tasks such as Conduct all Keyword Research & Analysis, Make a website Secure-HTTPS (if not), Optimization of Breadcrumb Navigation Links Structure, Baseline Keyword Ranking Report, Broken Link Optimization, and so on. In an embodiment, the hub computer platform and/or inspection station are configured to access the company's web site, which may be hosted by a third party computer system, to identify the existing state of on-page marketing activities. Thus, for example, as part of the inspection station, or otherwise as part of the hub computer platform, the system is configured to identify broken links on the company's web page. Based upon the findings, the system may be configured to determine a status for each of the steps, such as whether the “Broken Links Optimization” element on the checklist has a status of failed, need attention, or pass. For elements that are need attention or failed, the hub computer system is then configured to generate a list of tasks that should be performed to bring the element to a pass status.

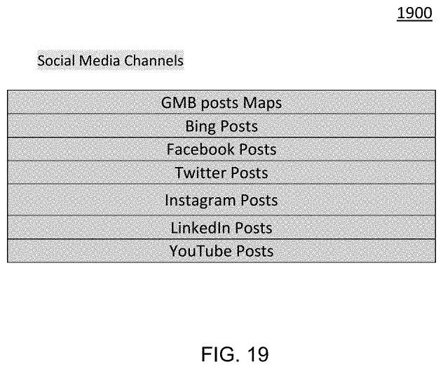

FIG. 19 depicts a social media channels list 1900 on which marketing may be targeted and on which the inspection station checklists may be applied, such as GMB Posts Maps, Bing Posts, Facebook® Posts, Twitter® Posts, Instagram® Posts, LinkedIn® Posts, and YouTube® Posts. The representative list is not exhaustive, and those of ordinary skill in marketing will understand that additional media channels may be identified. As part of the inspection station, or otherwise as part of the hub computer platform, the system may include checklists for assessing marketing on Bing®, Facebook®, Twitter®, etc. For example, the Inspection Station may include a checklist for assessing marketing on Twitter® Posts. The Inspection Station may be configured to access Twitter®, and to then compare the checklist to tweets on Twitter® that mention the company, such as posts that include negative comments or posts that include positive comments, and to assess the Twitter® Posts based upon the checklist. Based upon the findings, the system may be configured to determine a status for each of the items on the checklist. For elements that are need attention or failed, the hub computer system is then configured to generate a list of tasks that should be performed to bring the element to a pass status.

The inspection station may also be applied during or after completion of tasks, to assess whether the tasks have been completed. In this application, the inspection station may include checklists for reviewing status of completion of marketing tasks that were performed by either a marketing services provider company or a freelance marketing services provider, which were assigned by the company seeking marketing services. For example, if one of the tasks generate by the hub computer system is to update information on the Google maps interface, the system may be configured to pull data from the Google maps interface for the company and compare it to a checklist of the tasks that were supposed to be completed on the Google maps interface. The inspection station may be used in this manner in relation to any marketing tasks.

Steps of the methods performed herein may be performed in the order described in embodiments, or in other order, or with additional steps or with omission of one or more steps.

The methods described herein may be executed by one or more computer processors in communication with one or more data storage devices, display devices, user input devices, communication devices and other hardware devices. Such hardware devices may be co-located or location at more than physical location. In embodiments, cloud-based computing techniques, in which processing, communication and/or data storage are performed by use of third-party processing, communication and/or data storage resources of third parties, may be employed for one or more steps in the processes described herein.

Variations, modifications, and other implementations of what is described may be employed without departing from the spirit and scope of the disclosure. More specifically, any of the method and system features described above or incorporated by reference may be combined with any other suitable method, system, or device feature disclosed herein or incorporated by reference, and is within the scope of the contemplated systems and methods described herein. The systems and methods may be embodied in other specific forms without departing from the spirit or essential characteristics thereof. The foregoing embodiments are therefore to be considered in all respects illustrative, rather than limiting of the systems and methods described herein.

What is claimed is:

1. A hub computer platform for facilitating interaction between marketing service purchaser computer systems of marketing service purchasers and marketing service provider computer systems or marketing service providers, comprising:
one or more data storage devices configured to store budget data, marketing plan data, launching data, and reporting data for at least one marketing service purchaser and performance history and task data for a plurality of marketing service providers;
one or more computer processors in communication with the one or more data storage devices;
a communications device in communication with the one or more computer processors and the one or more data storage devices, and in communication with at least one marketing service purchaser computer system and one or more marketing service provider computer systems; and
a memory, coupled to the one or more computer processors, storing program instructions which, when executed by the one or more computer processors, cause the one or more computer processors to:
generate, for transmission by the communications device to the at least one marketing service purchaser computer system, one or more interfaces configured to receive background data concerning the marketing service purchaser;
generate, for transmission by the communications device to the at least one marketing service purchaser computer system, one or more interfaces configured to obtain budget data concerning the marketing service purchaser;
generate, for transmission by the communications device to the at least one marketing service purchaser computer system, one or more interfaces based upon the obtained budget data configured to obtain selection of specific budget terms to be applied to a marketing campaign for the marketing service purchaser;
generate, for transmission by the communications device to the at least one marketing service purchaser computer system, one or more interfaces configured to obtain planning data concerning types and quantities of marketing campaigns to be implemented based upon the obtained budget data and the selected budget terms;
generate, for transmission by the communications device to the at least one marketing service purchaser computer system and the one or more marketing service provider computer systems, based on the budget data, the selected budget items, and the planning data, a calendar of marketing campaigns to be implemented by one or more service providers for the service purchaser;
generate, for transmission by the communications device to the at least one marketing service purchaser computer system, one or more interfaces for launching, by the at least one marketing service purchaser, the marketing campaigns identified in the calendar of marketing campaigns, wherein the one or more interfaces includes an interface with tasks for assignment to the one or more marketing service providers;
responsive to assignment of the tasks to the one or more marketing service providers by the marketing service purchaser, generate, for transmission by the communications device to the one or more marketing service provider computer systems, one or more interfaces specifying the tasks to each of the one or more marketing service providers;
responsive to the launching of the marketing campaigns, receiving sales data from the marketing service purchaser computer system which reports the sales generated after the launching of the marketing campaigns;
responsive to receipt of the sales data relating to the sales generated after launching of the marketing campaigns, determining, based upon the sales data, if an adjustment of the marketing campaigns is required;
responsive to determination that the adjustment is required, adjusting the calendar of marketing campaigns to add additional marketing campaigns and launching the additional marketing campaigns; and
repeating the reporting, adjusting, and launching steps based upon the reported sales data.

2. The hub computer platform of claim 1, wherein the memory further stores instructions that, when executed, cause the one or more computer processors to:
generate, for transmission by the communications device to the at least one marketing service purchaser computer system, one or more interfaces depicting the performance history and the task data for the one or more marketing service providers;
wherein the performance history data comprises one or more of cost per lead data, cost per sale data, performance percentage on spend data, flat rate marketing management data, and whether accepting customers data from each of the one or more marketing service providers.

3. The hub computer platform of claim 1, wherein the one or more interfaces for launching the marketing campaigns comprises at least one interface, transmitted by the communications device to the at least one service purchaser computer system, depicting a flow chart identifying all launch activities including the marketing campaigns and the tasks for the marketing campaigns.

4. The hub computer platform of claim 1, wherein the one or more interfaces for launching the marketing campaigns comprises at least one interface, transmitted by the communications device to the at least one service purchaser computer system, depicting for selection a customized list of the one or more marketing services providers available for hire via the hub computer platform, and, for each of the one or more marketing services providers, cost per lead data, cost per sale data, performance on spend data, and flat rate marketing management data,
wherein the one or more marketing services providers comprises one or both of marketing services companies and marketing service freelance providers and wherein the customized list of marketing services providers is based upon the performance history data and the task data for the one or more marketing service providers; and
wherein the hub computer platform is configured to receive, from the at least one service purchaser computer system, data indicative of a selection of at least one of the one or more marketing services providers from the customized list of marketing services providers.

5. The hub computer platform of claim 4, wherein, responsive to receipt by the hub computer platform of the data indicative of the selection of the at least one of the one or more marketing services providers, the memory further stores instructions that, when executed, cause the one or more computer processors to:
generate, for transmission to the marketing services provider computer system of the selected marketing services provider, a solicitation requesting the marketing services providers to perform one or more tasks for which the marketing service provider has been selected.

6. The hub computer platform of claim 5, wherein, responsive to acceptance by the selected marketing services provider of the one or both of the marketing campaigns and the tasks for which the marketing services provider has been selected, the memory further stores instructions that, when executed, cause the one or more computer processors to:
generate, for the selected marketing services provider, an interface including selectable campaigns for which the selected provider is responsible;
responsive to receipt of a selected campaign, generate, for the selected campaign, an interface identifying the tasks to be performed by the selected service provider.

7. The hub computer platform of claim 1, wherein the memory further stores instructions that, when executed, cause the one or more computer processors to:
generate, for transmission to the marketing services purchaser computer system and the marketing services provider computer system of a selected marketing services provider, a communications interface for communication between the marketing services purchaser and the marketing services provider wherein the identity of the marketing services purchaser is anonymous.

8. The hub computer platform of claim 1, wherein the one or more interfaces configured to obtain background data concerning the service purchaser comprise a series of interfaces configured to obtain (1) a business type applicable to the service purchaser, and (ii) an industry type applicable to the service purchaser; and (3) a geographic region applicable to the service purchaser;
wherein a business type comprises one of a seasonal business type, a weather driven business type, a retail store business type, a professional business type, and a consistent business type.

9. The hub computer platform of claim 8, wherein the one or more interfaces configured to obtain planning data include interfaces configured to depict a plurality of ad types that may be selected for use in the marketing campaign, wherein the plurality of ad types are based upon the industry type applicable to the marketing service purchaser.

10. The hub computer platform of claim 1, wherein the one or more interfaces configured to obtain planning data include interfaces configured to obtain employee data and service data concerning (1) a number and type of revenue generating employees of the service purchaser; (2) types and costs of services performed by each type of revenue generating employees of the service purchaser;
wherein the calendar of marketing campaigns to be implemented by the service provider for the service purchaser is further based upon the employee and service data.

11. The hub computer platform of claim 10, wherein the memory further stores instructions that, when executed, cause the one or more computer processors to:
calculate a number of sales of each type of service required to satisfy budget requirements for the service purchaser based upon the background data, the budget data, the selected budget items, the planning data, the employee data, and the service data;
wherein the calendar of marketing campaigns is generated further based upon the calculated number of sales of each type of service.

12. The hub computer platform of claim 10, wherein the memory further stores instructions that, when executed, cause the one or more computer processors to:
calculate a number of and type of service leads required to satisfy budget requirements for the service purchaser based upon the background data, the budget data, the selected budget items, the planning data, the employee data, and the service data;
wherein the calendar of marketing campaigns is generated further based upon the calculated number of service leads of sales of each type of service;
wherein the type of service leads is based upon an industry type applicable to the service purchaser.

13. The hub computer platform of claim 18, wherein the memory further stores instructions that, when executed, cause the one or more computer processors to:
calculate, based upon the sales data, marketing performance data including cost per lead data, a cost per sale data, and return of investment data for each of the selected ad types implemented by the marketing campaign; and
generate, for transmission to the marketing services purchaser computer system, an interface depicting the cost per lead data, the cost per sale data, and the return of investment data for each of the selected ad types implemented by the marketing campaign.

14. The hub computer platform of claim 13, wherein the one or more interfaces configured to obtain planning data include interfaces configured to obtain trigger condition data for determining whether an adjustment of the marketing campaigns is required;
wherein the determination of whether an adjustment of the marketing campaigns is required is based upon a comparison of the sales data to the trigger condition data;
wherein the trigger condition data comprises one or more percentages below a target sales level;
wherein, when the sales data indicates that the sales were one of the one or more percentages below the target sales level, an adjustment of the marketing campaigns is required;
wherein the trigger data further comprises data indicative of a type of campaign to be implemented when the trigger condition occurs for each of the one or more percentages below the target sales level.

15. A system for facilitating interaction between marketing service purchaser computer systems and marketing service provider computer systems, comprising:
one or more marketing service purchaser computer systems;
one or more marketing service provider computer systems; and
a hub computer platform for facilitating interaction between marketing service purchaser computer systems and marketing service provider computer systems, comprising:
one or more data storage devices configured to store budget data, marketing plan data, launching data, and reporting data for at least one marketing service purchaser and performance history and task data for at least one marketing service provider;
one or more computer processors in communication with the one or more data storage devices;
a communications device in communication with the one or more computer processors and the one or more data storage devices, and in communication with at least one marketing service purchaser computer system and at least one marketing service provider computer system; and
a memory, coupled to the one or more computer processors, storing program instructions which, when executed by the one or more computer processors, cause the one or more computer processors to:
generate, for transmission by the communications device to the at least one marketing service purchaser computer system, one or more interfaces configured to receive background data concerning the marketing service purchaser;
generate, for transmission by the communications device to the at least one marketing service purchaser computer system, one or more interfaces configured to obtain budget data concerning the marketing service purchaser;
generate, for transmission by the communications device to the at least one marketing service purchaser computer system, one or more interfaces based upon the obtained budget data configured to obtain selection of specific budget terms to be applied to a marketing campaign for the marketing service purchaser;
generate, for transmission by the communications device to the at least one marketing service purchaser computer system, one or more interfaces configured to obtain planning data concerning types and quantities of marketing campaigns to be implemented based upon the obtained budget data and the selected budget terms;
generate, for transmission by the communications device to the at least one marketing service purchaser computer system and the one or more marketing service provider computer systems, based on the budget data, the selected budget items, and the planning data, a calendar of marketing campaigns to be implemented by one or more service providers for the service purchaser;
generate, for transmission by the communications device to the at least one marketing service purchaser computer system, one or more interfaces for launching, by the at least one marketing service purchaser, the marketing campaigns identified in the calendar of marketing campaigns, wherein the one or more interfaces includes an interface with tasks for assignment to the one or more marketing service providers;
responsive to assignment of the tasks to the one or more marketing service providers by the marketing service purchaser, generate, for transmission by the communications device to the one or more marketing service provider computer systems, one or more interfaces specifying the tasks to each of the one or more marketing service providers;
responsive to the launching of the marketing campaigns, receiving sales data from the marketing service purchaser computer system which reports the sales generated after the launching of the marketing campaigns;
responsive to receipt of the sales data relating to the sales generated after launching of the marketing campaigns, determining, based upon the sales data, if an adjustment of the marketing campaigns is required;
responsive to determination that the adjustment is required, adjusting the calendar of marketing campaigns to add additional marketing campaigns and launching the additional marketing campaigns; and
repeating the reporting, adjusting, and launching steps based upon the reported sales data.

16. The system of claim 15, further comprising a sales data API accessible by the at least one marketing service purchaser computer system and configured for enabling the at least one marketing service purchaser computer system to provide the sales data to the hub computer platform.

17. The system of claim 15, wherein the one or more interfaces configured to obtain planning data include interfaces configured to obtain trigger condition data for determining whether an adjustment of the marketing campaigns is required;
wherein the determination of whether an adjustment of the marketing campaigns is required is based upon a comparison of sales data to the trigger condition data.

18. A hub computer platform for facilitating interaction between marketing service purchaser computer systems of marketing service purchasers and marketing service provider computer systems or marketing service providers, comprising:
one or more data storage devices configured to store budget data, marketing plan data, launching data, and reporting data for at least one marketing service purchaser and performance history and task data for a plurality of marketing service providers;
one or more computer processors in communication with the one or more data storage devices;
a communications device in communication with the one or more computer processors and the one or more data storage devices, and in communication with at least one marketing service purchaser computer system and one or more marketing service provider computer systems; and
a memory, coupled to the one or more computer processors, storing program instructions which, when executed by the one or more computer processors, cause the one or more computer processors to:
generate, for transmission by the communications device to the at least one marketing service purchaser computer system, one or more interfaces configured to receive background data concerning the marketing service purchaser;
provide, for transmission by the communications device to the at least one marketing service purchaser computer system, a budget data API configured for enabling the at least one marketing service purchaser computer system to automatically provide the budget data to the hub computer platform;
generate, for transmission by the communications device to the at least one marketing service purchaser computer system, one or more interfaces based upon the provided budget data configured to obtain selection of specific budget terms to be applied to a marketing campaign for the marketing service purchaser;
generate, for transmission by the communications device to the at least one marketing service purchaser computer system, one or more interfaces configured to obtain planning data concerning types and quantities of marketing campaigns to be implemented based upon the obtained budget data and the selected budget terms;
generate, for transmission by the communications device to the at least one marketing service purchaser computer system and the one or more marketing service provider computer systems, based on the budget data, the selected budget items, and the planning data, a calendar of marketing campaigns to be implemented by one or more service providers for the service purchaser;
generate, for transmission by the communications device to the at least one marketing service purchaser computer system, one or more interfaces for launching, by the at least one marketing service purchaser, the marketing campaigns identified in the calendar of marketing campaigns, wherein the one or more interfaces includes an interface with tasks for assignment to the one or more marketing service providers;
responsive to assignment of the tasks to the one or more marketing service providers by the marketing service purchaser, generate, for transmission by the communications device to the one or more marketing service provider computer systems, one or more interfaces specifying the tasks to each of the one or more marketing service providers;
provide, for transmission by the communications device to the at least one marketing service purchaser computer system, a sales data API configured for enabling the at least one marketing service purchaser computer system to automatically report, to the hub computer platform, the sales generated after the launching of the marketing campaigns;
responsive to receipt of the sales data relating to the sales generated after launching of the marketing campaigns, determining, based upon the sales data, if an adjustment of the marketing campaigns is required;
responsive to determination that the adjustment is required, adjusting the calendar of marketing campaigns to add additional marketing campaigns and launching the additional marketing campaigns; and
repeating the reporting, adjusting, and launching steps based upon the reported sales data.

19. The hub computer platform of claim 18, wherein the memory further stores instructions that, when executed, cause the one or more computer processors to:
automatically generate, upon completion of a service for a customer, for transmission to a customer computer system, a referral request for referring the marketing services purchaser, wherein the referral request includes information relating to a potential reward for one or more referrals and a forwardable electronic message including the referral;
generate, for transmission to the marketing services purchaser computer system, a user interface for receiving and storing referral information relating to a customer;
determining, based upon the received and stored referral information relating to a customer, whether the customer qualifies for a reward.

20. The hub computer platform of claim 18, wherein the memory further stores instructions that, when executed, cause the one or more computer processors to:
access at least one third party computer system comprising a marketing channel on which the marketing services purchaser has existing advertising;
compare, based upon the access of the at least one third party computer system, the existing advertising on the marketing channel to a checklist of desired marketing on the marketing channel;
wherein generation of the interfaces including the tasks for assignment to the one or more marketing service providers is based upon the comparison of the existing advertising to the checklist of desired marketing.
